(19) United States
(12) Patent Application Publication
(10) Pub. No.: US 2025/0022643 A1
(43) Pub. Date: Jan. 16, 2025

(54) HIGH-EFFICIENCY MACHINE

(71) Applicant: Matthew Moran, Vernon, NY (US)

(72) Inventor: Matthew Moran, Vernon, NY (US)

(21) Appl. No.: 18/714,262

(22) PCT Filed: Dec. 2, 2022
(86) PCT No.: PCT/US2022/051630

§ 371 Date: May 29, 2024

Related U.S. Application Data
(60) Provisional application No. 63/285,380, filed on Dec. 2, 2021.

(51) Int. Cl. H01F 7/02

(52) U.S. Cl. CPC H01F 7/0242

(57) ABSTRACT

The systems and methods disclosed herein provide improvements in motion or energy transfer efficiency by incorporating long-lasting energy sources of gravity and magnetism. By providing a magnetic “lift-assist” in a particular geometric configuration, an improvement in output energy efficiency can be obtained. For example, improvements in the output/input energy ratio can be 10% and more. Inclined motion and piston-driven linear motion systems are also disclosed herein. The systems and method disclosed herein improve efficiency of rotation driven devices and other mechanisms.

### CROSS-REFERENCE TO RELATED APPLICATIONS

This application claims the benefit of priority to U.S. Provisional Application 63/285,380, filed Dec. 2, 2021. That prior application is incorporated herein by reference.

### FIELD

The present disclosure relates generally to machines that transfer motion or energy, such as rotational or vertical motion.

### BACKGROUND

Researchers in various industries are constantly seeking ways to improve efficiency of machines or components of their machines. Even a small improvement in the amount of energy output from a system given the same input to the system can realize important gains in speed, energy, and cost-effectiveness of various industrial processes. Many of these machines involve simple mechanics that transfer motion and/or convert motion into energy. Often, a rotational motion or a vertical motion is involved, and the machine is working against inertia, gravity, and friction and losing efficiency throughout the process due to these effects.

A perfect machine with no energy losses would produce an energy output/input ratio of 1. This type of “unity” machine is not achievable with current technology. However, it is greatly desirable to improve this ratio.

Examples of devices and industries that could greatly benefit from even a small improvement in reduced energy loss or an increase in output/input ratio include, for example, windmills, watermills, generators, energy storage, flywheel devices, motors, engines, automotive vehicles, bicycles/tricycles, and boats.

Long-lasting physical forces such as magnetism and gravitational forces, can be incorporated in machines. However, attempts to leverage these forces to achieve a substantial increase in energy output when the entire system is considered have been met with little success.

Magnets can attract or repel, but also have opposing forces that are difficult to shield or keep out of the way of negatively influencing the movements of the machine. Similarly, gravity, of course, only assists motion and energy in one direction, and directly opposes it in the opposite direction. Various attempts of converting potential energy to kinetic energy and using the kinetic energy to regenerate the potential energy have been made; however, extracting tangible benefits from this approach have been limited.

### SUMMARY

The following is a brief summary of subject matter that is described in greater detail herein.

Clockface notation is used herein. When the rotation is clockwise, typical clockface notation identifies the positioning and when the rotation is counter-clockwise, a counter-clockface notation identifies the positioning. Thus, when a range of, e.g., 6 to 9 o'clock is stated herein, this should be interpreted as being 6 to 9 o'clock for clockwise rotation, and 6 o'clock to 3 o'clock (by standard clockwise clockface notation) for counterclockwise rotation. The use of this notation is meant to cover the same upward motion of the wheel/rotor whether the direction of rotation is clockwise or counterclockwise.

The systems and methods disclosed herein provide an improvement in motion or energy transfer efficiency by incorporating long-lasting external energy sources of gravity and magnetism. By providing a magnetic “lift-assist” in a particular geometric configuration an improvement in output energy can be obtained. For example, improvements in the output/input energy ratio can be on the order of 10% or more. The systems and method disclosed herein improve efficiency of rotational and inclined linear lift devices and other mechanisms.

In an embodiment, a motion transfer system includes: a wheel, configured to rotate vertically around a center axis of rotation, the wheel including a rim with a permanent magnetic array arranged on the rim that forms a magnetic array around the wheel; and a lift assist assembly including a permanent magnetic assembly configured to exert a magnetic repelling force against the permanent magnetic array in at least a portion of an area including 6 o'clock to 9 o'clock.

In an embodiment, a motion transfer system includes: a first arm having a first magnetic rotor and a second magnetic rotor on each end of the first arm, and a second arm having a first magnetic rotor and a second magnetic rotor on each end of the second arm. The first arm and second arm are coupled with a sliding mechanism to a hub and are configured to rotate vertically about a central axis. The first and second arm are configured to slide radially to a maximum outer radius and a minimum inner radius as they rotate about the central axis. A lift assist assembly is also part of the system and it includes a permanent magnet assembly, and is configured to exert a magnetic repelling force against the first and second magnetic rotors on the first and second arms in at least a portion of an area including 6 o'clock to 8 o'clock.

In an embodiment, a method for transferring motion, includes the steps of applying a starting force to begin rotation of a magnetic rotor rotating vertically on a horizontal axis; and applying a magnetic repelling force against the magnetic rotor in at least a portion of an area of the rotation including 6 o'clock to 9 o'clock.

A motion transfer system includes: a piston aligned for linear motion and moveable between a top and a bottom vertical position; a first wheel with a first coupling arm rotatably coupled to the first wheel and rotatably coupled to the piston, a piston magnet coupled to the piston; and a rebound magnet aligned with the bottom vertical position of the piston magnet so as to exert a repelling magnetic force on the piston magnet at the bottom vertical position. The system is configured such that the piston moves up and down as the first wheel rotates.

A travel system includes: a ramp, including a series of stator magnets under a ramp surface, oriented along a diagonal parallel with the ramp surface or plus or minus 20% parallel with the ramp surface; and a ramp vehicle, including first and second wheels in contact with the ramp surface, the first and second wheels each having one or more wheel magnets configured to interact with and be repelled by the stator magnets when the ramp vehicle is in contact with the ramp, the one or more wheel magnets being configured to lessen the weight of the ramp vehicle on the ramp surface.

### BRIEF DESCRIPTION OF THE FIGURES

FIG. 1 is a front elevation view of an embodiment of a lift assisted rotational motion transfer device.

FIG. 2 is a front elevation zoomed-in view of an embodiment of a lift assist assembly.

FIG. 3 is an x-y graph showing an example of a curve fit to a shape of a magnet for an embodiment of an inner area of the bottom support layer of a lift assist assembly.

FIG. 4 is an x-y graph showing an example of a curve fit to a shape of a magnet for another embodiment of a lift assist assembly.

FIG. 5 is a zoomed-in view of an embodiment of a rotational motion transfer system, wherein the quarter of the system from about 6 o'clock to 9 o'clock is shown along with exemplary magnetic flux lines.

FIG. 6 is a graph showing an example of the magnetic force in an embodiment of the system in an upward vector (x-axis) as a wheel magnet progresses through the 6 o'clock to 9 o'clock rotation (y-axis).

FIG. 7A is front elevation view of a second embodiment of a lift assisted rotational motion transfer device.

FIG. 7B is a front elevation view showing the system of FIG. 7A with illustrations of the rotor head as it moves around the circle.

FIG. 8A and FIG. 8B depict a zoomed in view of the second embodiment of the motion transfer system, wherein the area of the lift assist assembly from about 6 o'clock to about 8 o'clock is shown with exemplary magnetic flux lines.

FIG. 9A is a diagram with a line tracing movement of a center point of a rotor magnet, as it progresses around the axis of an exemplary system.

FIG. 9B is a front elevation view showing the system of FIG. 9A with illustrations of the rotor head as it moves around the circle.

FIG. 9C is a front elevation view of a two-stage system tracing multiple instances of the rotor head as it moves around the circle.

FIG. 10 is a graph showing the distance of a single rotor magnet from a center axis (y-axis), as it travels around the circle (x-axis is rotational position in clock notation).

FIG. 11 is a cross-sectional and zoomed-in view of an embodiment of the system showing an end of a first arm detailing a magnetic rotor.

FIG. 12 is a diagram showing the shape and side angles of an exemplary end of a first arm.

FIG. 13 is an x-y graph showing an example of a curve fit to a shape of a magnet for another embodiment of a lift assist assembly.

FIG. 14 is a diagram showing movement of two-stage rotational motion transfer systems that can be used with a telescoping arm system.

FIG. 15 is a photograph showing the test apparatus used in Examples 1 and 2.

FIG. 16A is a side elevation view of an exemplary ramp and ramp vehicle of a travel system.

FIG. 16B is a front elevation view of an exemplary ramp and ramp vehicle of a travel system.

FIG. 17 is a side view of an exemplary motion transfer system.

FIG. 18A is a side view of an exemplary modified system in a first position.

FIG. 18B is a side view of an exemplary modified system in a second position.

FIG. 19A is a side view of another exemplary modified system in a first position.

FIG. 19B is a side view of another exemplary modified system in a second position.

### DETAILED DESCRIPTION

Various technologies pertaining to a highly efficient motion transfer machine are discussed, wherein like reference numerals are used to refer to like elements throughout. It is to be understood that the functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or”. In addition, the articles “a”, “an” and “the”, as used in this application and the appended claims, should generally be construed to mean “one or more” unless specified otherwise or clear from the context to be directed to a singular form.

The present disclosure describes improvements in efficiency in energy output/input in a motion transfer machine. This is done by the use of a gravitational force to produce kinetic energy which is recycled for potential energy with the assistance of a magnetic force to overcome the gravitational force on the vertical ascension to achieve overall energy gains. An additional benefit is the reduction of friction due to the magnetic equilibrium at a portion of the motion, leaving air resistance and electromagnetic drag, potentially further improving efficiency.

Adjusting for various magnetic moments in a series of magnets to produce a consistent field with low resistance to a magnetic object entering the field, in particular, from an object with a rotational motion (magnetic rotor) is difficult. A magnetic material responds to exterior magnetic fields and produces its own magnetic field. The strength of the magnetic field it produces at a given time is proportional to the magnitude of its magnetic moment. In addition, when the magnet is put into an external magnetic field, produced by an exterior magnet, it is subject to a torque tending to orient the magnetic moment parallel to the field. The amount of this torque is proportional both to the magnetic moment and the external field. A magnet may also be subject to a force driving it in one direction or another, according to the positions and orientations of the magnet and source. If the field is uniform in space, the magnet is subject to no net force, although it is subject to a torque. To make an efficient rotational device with multiple magnets, the magnetic moments at various positions should be tailored to enhance propulsion or at least neutralize friction, the torque on the moving magnet due to these magnetic fields must be managed as well. Merely consistently spacing and dimensioning magnet stators along a rotational pathway of a magnetic rotor does not address all these considerations. It results in a repulsion/attraction force where the rotor first interacts with the magnet stators, does not account for other repulsion interactions, and does not sufficiently aid in the most needed area of lifting force.

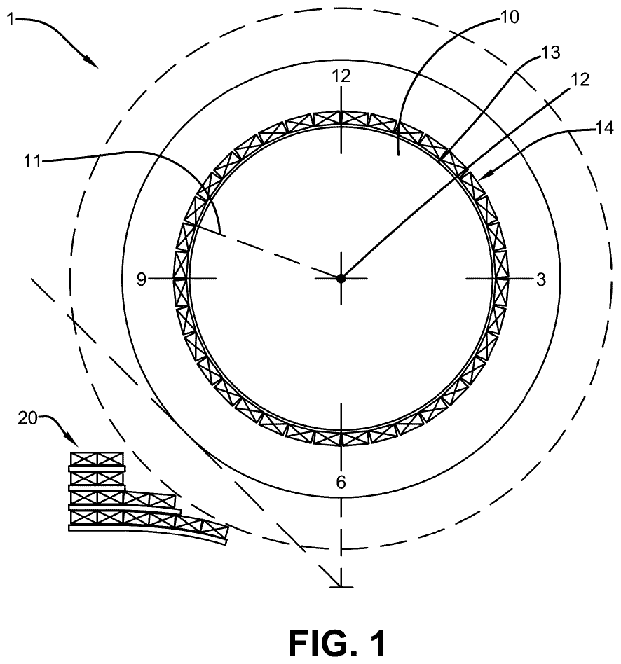

Through significant research, trial, and error, it was determined that an “initial pickup” geometry designed for placement just after 6 o'clock (see FIG. 1) in a clockwise rotational motion system greatly reduces or eliminates the initial repulsive force allowing the magnetic rotor to enter a magnetic field with little repulsive force and to be pushed along by the magnet stators. In addition, an ending portion of stacked or stronger magnets with a field oriented upwards at or prior to 9 o'clock was found to provide a synergistic vertical lift assist to the rotational motion of the magnetic rotor. Furthermore, the strategic horizontally inclined and amplified magnetic assisting system for upward lift for lifting an object vertically differentiates from prior systems. Prior systems focus on suspending/lifting (or a combination of the two) or use a horizontal motion. Strategically placed/stacked magnets disclosed herein assist the rotating, transitional, and/or plunging structure at exactly the precise time to produce a mechanical advantage that produces gains in low friction and leverages gravity for assistance. Embodiments of the lift assist devices disclosed herein combine magnetic uniformity through placement of individual magnets or a custom poured magnet to have smoothed flux lines to influence its surface fields at strategically specific stability moments to both reduce friction and make the “work” portion of the “conservation of energy” equation more efficient on a continual basis.

In an embodiment, a magnetic rotor is fitted with a linear sliding arm mechanism, making it capable of moving radially. Through significant research, trial, and error, a geometry of stator magnets was determined to apply magnetic force, in the 6 o'clock to 9 o'clock range, on the magnetic rotor to slide the magnetic rotor on the sliding arm mechanism diagonally up towards the center of the rotational axis and concurrently slide a second end out in the 12 o'clock to 3 o'clock range. This has the effect of reducing the torque required to rotate the system and further increasing efficiency of the system.

When the magnetic stator is positioned properly against a magnetically repelling rotor and optionally amplified with stronger magnets/magnetic force behind it, the system can exhibit a lift assist feature that conventional wheel contact, meshing gears, or otherwise friction-inertia cannot accomplish alone. A ramp-up feature reduces both the magnetic friction-inertia of having intersecting flux lines (arcs-rounds), but also the regular stress/friction on the shafted bearings for the most efficient application of “work” where it is needed most. By amplifying the crest of the magnetic field in strategic locations and layering the magnetic field into a ramp-like structure, the magnetic force can, in a first embodiment, exert an efficient lift on a rotating mass, e.g., a flywheel, gear, turbine, planetary/epicyclic or sun and planet gear/system, sprocket, pulley, cam, crankshaft counterweight device, gyroscope, or wheel at or near the moment when the potential energy of the rotor is low and the kinetic energy is low. This achieves measurable efficiency gains. In a second embodiment, such an approach can directionally move via a linear slide shaft mechanism the magnetic rotor into a mechanical advantage position with high efficiency/minimal work.

Other embodiments are also provided that leverage these teachings to efficiently transfer rotational motion into vertical or other types of motion or energy. The resulting energy efficient devices can provide efficiency gains to power generation systems using centrifugal force and/or flywheel/gear-train enhanced systems have to expend less initial combustion, pneumatic, steam, hydraulic, hydrogen, fluid/waterjet, sonic, nuclear, electrical, or other energy for power generation.

An embodiment of a lift assisted rotational motion transfer system 1 is shown in FIG. 1. This system 1 is superimposed over a common clockface notation in FIG. 1 only for purposes of illustration and specifying certain features relating to the system 1.

In the system 1, a wheel 10 with a center axis 12 of rotation is suspended above a base surface (not shown). The axis 12 of rotation can be suspended so that it is freely able to spin on the axis on one or both sides of the wheel 10, or could be suspended from an interior support placed between a front and back surface of the wheel. Ball bearings and lubrication can be employed at the rotational axis 12 and can be used to improve (reduce) friction losses. Other methods of suspension could also be used including a magnetic bearing that levitates the axis 12. (See e.g., U.S. Pat. No. 5,111,102, incorporated herein by reference.)

Around the outer rim 13 of the wheel 10 are a plurality of permanent wheel magnets 14 that form a circular magnetic array producing a magnetic field around the wheel 10. These wheel magnets 14 are secured to the outer rim 13 by adhesive or mechanical coupling. The wheel 10 has a radius 11 extending to the outer surface of the wheel magnets 14. In an embodiment, the wheel magnets 14 could also be a magnetic strip. In an embodiment, they are oriented in the same direction (north or south) and are spaced equally apart. In an embodiment, they may be arranged to form a Halbach array (discussed further below). In an embodiment, the wheel magnets 14 may be arranged so that a portion of the wheel 10, e.g., 1 to 30 degrees, or 5 to 10 degrees of the 360-degree circle is free of a magnet. In an embodiment, there may be a disruption in the consistent field in this area of the wheel. The disruption in the field provides potential for electromagnetic monitoring of the rotation. In addition, in an embodiment, one or more magnets can be angled and configured as a weighted cam/counterweight, such as in various portions (e.g., crankpin journals) of a camshaft. In an embodiment, wheel magnets 14 are only attached at the end of blade, e.g., a windmill blade, instead of being consistently patterned on a wheel 10.

A lift assist assembly 20 magnetically influences the wheel magnets 14. The lift assist assembly 20 is located between 6 o'clock and 9 o'clock on the system (lower-left quadrant in FIG. 1) for clockwise motion and applies a magnetic repelling force to the wheel magnets 14 in at least a portion of an arc including 6 o'clock to 9 o'clock. (If counter-clockwise motion is desired the lift assist assembly would be in the lower-right quadrant instead.) This provides the lift assist where additional energy is needed most at or near the moment when the potential energy of the wheel magnets 14 in this location is low and the kinetic energy is also low.

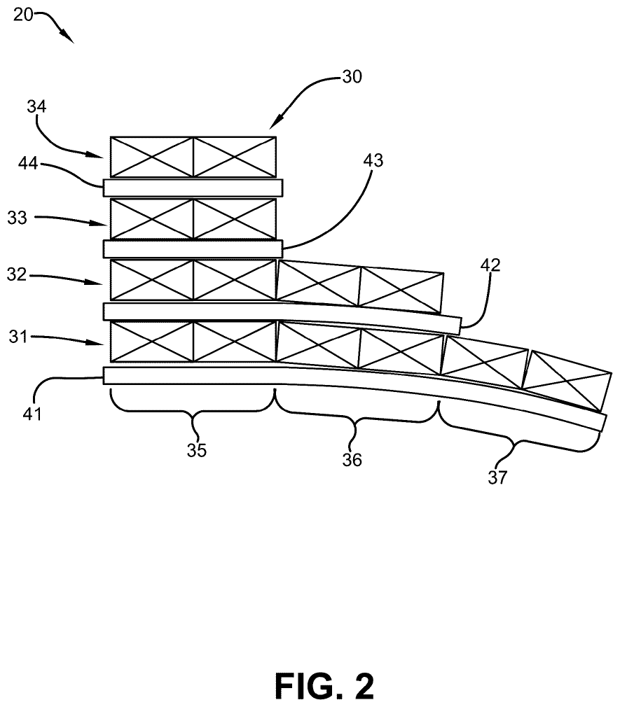

FIG. 2 shows a close-up view of just the lift assist assembly 20. In an embodiment, there are three vertical layers (or steps) of stator magnets 30, which together form a magnetic assembly (and in an embodiment can be a single poured or cast magnet): a bottom layer 31, a middle layer 32, and a top layer 33 and three horizontal areas, an outer area 35, a middle area 36, and an inner area 37. In an embodiment, the stator magnets 30 are coupled to bottom, middle, and top base supports (41, 42, 43), respectively, with support layers 41, 42, 43 corresponding to the vertical layers 31, 32, 33. In an embodiment, as shown, a supplemental top support layer 44 overlaps the top support layer 43, and is coupled to a supplemental top stator magnet layer 34.

In an embodiment, the support layers 41, 42, 43, 44 are made of a rigid thermoplastic that provides stability and is not deformed by the magnetic forces at work in the system. In other embodiments, other non-ferromagnetic materials may be used. The coupling can be mechanical, e.g., with a screw or bolt running through the stator magnets 30 and into the support and/or with an adhesive. The strength of the coupling should be sufficient to withstand the magnetic forces at work in the system without the stator magnet being moved. In an embodiment, the support layers 41, 42, 43, 44 are coupled to each other, e.g., by a bolt extending through each of them.

In an embodiment, the bottom layer 31 extends through the outer and middle areas 35, 36 at an angle parallel to a line extending from 9 to 3 o'clock relative to the wheel, which may also be perpendicular to the direction of the gravitational force of the earth (straight down, as determined by a plumb bob). In an embodiment, two of the vertical layers (e.g., 30, 33, or 33, 32) of the lift assist assembly 20 partially horizontally overlap (or flow over) a lower layer (e.g., 32 or 31) and strengthen a portion of a magnetic field of the bottom layer 31.

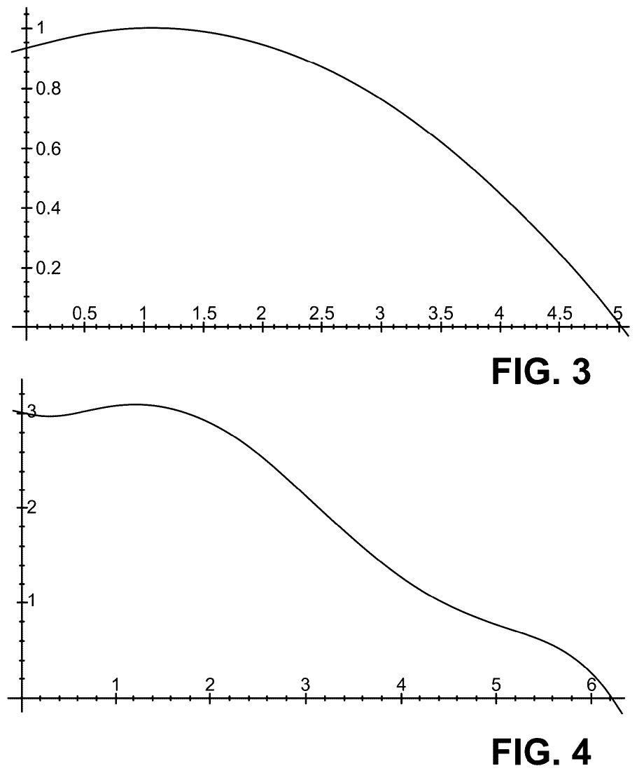

In the inner area 37, the bottom support layer 41 is bent downward at a negative slope, i.e., as the bottom support layer 41 extends toward the vertical mid-line of the wheel 10 (in this case, a line extending through from 12 o'clock to 6 o'clock) the bottom support layer 41 drops lower. The stator magnets 30 follow the curvature or downward slope of the bent bottom support layer 41. In particular a top surface of the stator magnets 30 slopes downward as the lift assist assembly 20 extends toward the vertical mid-line of the wheel 10. In an embodiment, this downward slope is −1 to −6 (negative meaning dropping), that is 1 to 6 units of downward vertical distance for every 1 unit of horizontal distance (toward the vertical mid-line of the wheel 10, such as −2 to −5, or −2.5 to −4.5. In an embodiment, the average angle of negative slope from horizontal of this first area 137 is 4 to 28 degrees, such as 6 to 24, or 8 to 23 degrees. In an embodiment, the inner area 37 of the bottom support layer 41 has a curvature with a section that is parabolic, such as, for example, a section or the entire inner area 37 following the shape of the second order polynomial y=0.936+0.1291429x−0.06285714x2 (Equation I) in the range of x=1 to 5, where the top surface of the bottom support layer 41 and the top layer of the stator magnets 30 at the beginning of the inner area 37 are defined as y=1. FIG. 3 shows an example of this curve. In an embodiment, each of the variables in Equation I may vary −15% to 15%, such as −10% to 10%, or −5% to 5% and/or for any x-coordinate, the y coordinate can vary by −15% to 15%, such as −10% to 10%, or −5% to 5%. This inner area 37 is sloped in a manner to smooth the transition from no magnetic influence to the heavier magnetic influence of the middle area 36, thereby providing a ramp instead of a bump or step that might cause a high friction event or even stopped the motion of the system 1.

In the middle area 36, there are two layers of stator magnets 30 with a magnetic field oriented to push the wheel magnets 14 upward, with at least one overlapping stator magnet 30 that reinforces the strength of the magnetic field, such that the magnetic field is stronger than in the inner area 37. The middle area may be slightly sloped downward as the lift assist assembly 20 extends toward the vertical mid-line of the wheel 10. Slope may be, for example following the same slope as in Equation I with the same variables listed above, or as modified by a factor 0.7 to 0.99, such as 0.75 to 0.95, or 0.8 to 0.9.

In the outer area 35, there are three or (as shown) four layers of stator magnets 30 with a magnetic field oriented to push the wheel magnets 14 upward, with at least two overlapping stator magnets 30 that reinforce the strength of the magnetic field of the bottom layer 31, such that the magnetic force is stronger than in the inner area 37 and the middle area 36. More than four layers can also overlap in this area, e.g., 5 to 20, or 6 to 15, or 7 to 10. Here there are two magnet stators 30 oriented to strengthen the magnetic field in each of the vertical layers 31, 32, 33, providing a strong push upward at a vertical column centered outside of the radius of rotation of the wheel at 9 o'clock, such as 1 to 6 inches, 1.5 to 4 inches, or 2 to 3 inches outside the outer radius of rotation of the wheel 10—the distance to the vertical column following a horizontal line outward at 9 o'clock. These distances are for a wheel 10 with a radius of 6 inches. For larger or smaller scale embodiments, the horizontal distance to the column from the 9 o'clock outer radius of the wheel 1 may be, for example, 0.167 to 1 times the radius of the wheel (r), such as 0.25r to 0.75r the radius of the wheel, or 0.33r to 0.5r. In an embodiment, the stator magnets 30 in this vertical column are the strongest area of the magnetic field of stator magnets 30 and provide the strongest column of influence on the wheel 10. In an embodiment, the outer area 35 can be twice to five times as strong as the inner area 37, e.g., 2.5 to 4 times as strong or 2.75 to 3.5 times as strong.

In an embodiment, the lift assist assembly 20 can, instead of using individual stator magnets 30, be poured to approximate the same magnetic field as described above, wherein each of the horizontal areas 37, 36, 35 progressively increase in strength. In an embodiment, the top surface of the poured magnet can have a curvature with at least two inflection points, one each in the middle and inner horizontal areas 36, 37, and, for example, may correspond to a cross-section following the shape of the fifth order polynomial y=2.989939−0.273184x+0.7291161x²−0.4820018x³+0.09897075x⁴−0.006619098x⁵ (Equation II) in the range of x=0 to 6. FIG. 4 shows an example of this curve. In an embodiment, each of the variables in Equation II may vary −15% to 15%, such as −10% to 10%, or −5% to 5% and/or for any x-coordinate, the y coordinate can vary by −15% to 15%, such as −10% to 10%, or −5% to 5%.

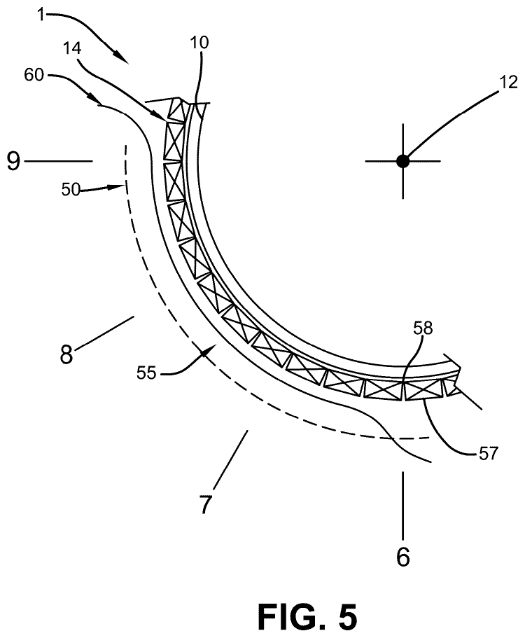

FIG. 5 depicts a zoomed-in view of the rotational motion transfer system 1, wherein the quarter of the wheel 10 from about 6 o'clock to 9 o'clock is shown. A first magnetic flux line 50 is shown that corresponds to the wheel magnets 14 and a second magnetic flux line 60, which is of a same and repelling polarity than the first magnetic flux line 50 is also shown. There is an overlapping area 55 between the lines where the magnetic fields interact and exert a force on the wheel 10 and the lift assist assembly 20.

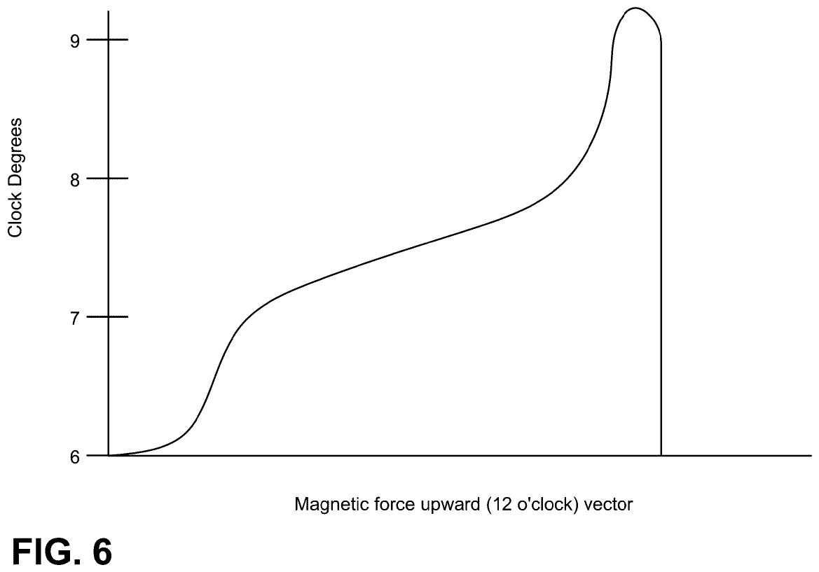

FIG. 6 shows an example graph of the magnetic force applied to a wheel magnet 14 in an upward vector (x-axis) as a wheel magnet 14 progresses through the 6 o'clock to 9 o'clock rotation (y-axis). This is an approximation and can vary in other embodiments of the system 1. In an embodiment, there at least two inflection points in the graph of magnetic force, and the upward magnetic force has an increasing slope as it progresses along the 6 o'clock to 9 o'clock rotation. In an embodiment, the upward vector of force is greatest between 8 o'clock and at or just before 9 o'clock, and rapidly tails off after 9 o'clock as rotational/angular momentum turns up/away towards 12 o'clock.

In an embodiment, the only magnetic influence on the system 1 is exerted in the area of from 6 o'clock to 9 o'clock, such as 6:01 to 8:55, or 6:05 to 8:30 o'clock. and/or the only magnets acting on the system 1 are in an arc around the axis 112 of from 6 o'clock to 8 o'clock, such as 6:01 to 7:55, or 6:05 to 7:30 o'clock. This is opposed to and distinct from magnetic lifts on linear, non-inclined, or non-rotational systems.

In a particular embodiment of the system 1 described above in FIG. 1 the wheel magnets 14 and stator magnets 30 are 0.5 inches tall and 1 inch in length and width. The wheel magnets 14 are circumferentially spaced about ⅛ inch apart at their outer surface 57 and the wheel 10 has a 13-inch outer diameter. The wheel magnets 14 are close to or touching each other at their innermost radial edge 58. The magnetic flux from the wheel magnets 14 extends with force about 4 inches from the outer diameter of the wheel 10. Larger magnets may result in a magnetic flux extending with force over 6 inches, and smaller magnets would be smaller, e.g., 2 inches or less. In this embodiment, the supplemental top stator magnet layer 34 of the stator magnets 30 is an extra set of stator magnets. Effectively, this raises the height of the top layer by about ½ inch and doubles the magnetic flux of the top layer. It should be understood that changing the magnetic flux of the system 1 can be done by either adding or subtracting magnets, or using stronger or weaker magnets by changing their sizes or type. Experiments with this system 1 indicate that prior to about 8 o'clock the wheel magnets 14 and stator magnets 30 are engaged in equilibrium and at 8 to 9 o'clock there is a strong push upward from the magnetic repulsion.

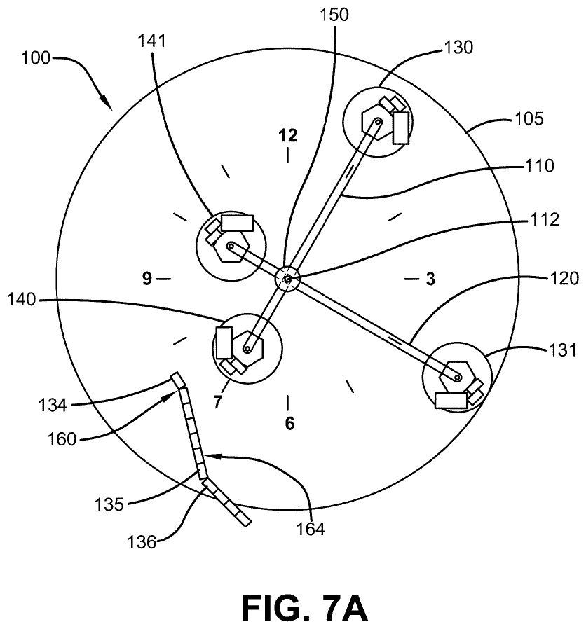

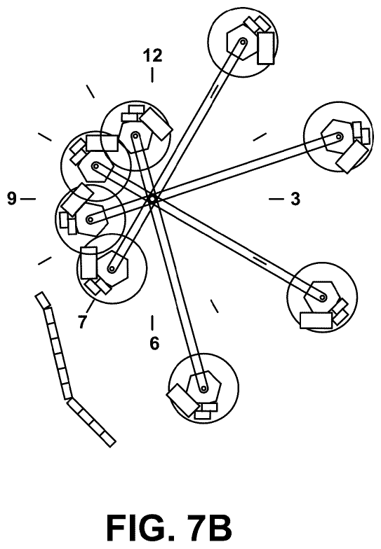

FIG. 7A shows an embodiment of a motion transfer system 100 with first and second arms 110, 120. FIG. 7B shows a detailed view of the rotor head in motion around the circle. A circle with radius 105 is depicted for illustration purposes to show the maximum radius of the first and second arms when fully extended. The first and second arms 110, 120 both slide through a central hub 150 and rotate around the axis 112. At each end of the first arm 110 are first and second magnetic rotors 130, 140. At each end of the second arm 120 are first and second magnetic rotors 131, 141. The first and second arms 110, 120 are slidingly coupled to a central hub 150. In an embodiment, the sliding coupling mechanism, which may be a linear slide block, includes a through-hole in the central hub 150 that closely fits with the cross-section of the first and/or second arms 110, 120. In an embodiment the first and/or second arms 110, 120 have a circular cross-section. In an embodiment, the first and/or second arms 110, 120 have a square, U-shape or other non-circular cross-section to prevent rotation about the long axis of the first and/or second arms 110, 120.

In an embodiment, the sliding coupling mechanism at the central hub 150 for the first magnetic rotor 131 is close in axial distance to the second magnetic rotor 141, such that both first and second magnetic rotors 131, 141 can be magnetically influenced by the same lift assist assembly 160 approximately equally after rotation, even though they are axially spaced. The first and second arms 110, 120 can be placed at 90-degree angles from each other. Effort should be made to configure the device to isolate the rotors 131, 141 and/or arms 110, 120 from magnetically interfering with each other. In an embodiment, this can be done by spacing the arms 110, 120 out axially. For example, there may be a 2-to-100-inch axial gap (e.g., 4 to 30, or 5 to 8 inches) between a first arm 110 and second arm 120, or additional arms.

The lift assist assembly 160 in this embodiment includes permanent stator magnets 164 that intrude into the radius 105 blocking the maximum extension of the first and second arms 110, 120 and exerts a magnetic repelling force on the magnetic rotors 130, 131, 140, 141 in at least a portion of an arc including 6 o'clock to 8 o'clock, 6:30 to 7:30, or 6:45 to 7:15. In an embodiment, the portion of the arc can include 6:10 to 8:55 o'clock. In an embodiment, the portion of the arc can include 6:10 to 8:55 o'clock.

The permanent stator magnets 164 form a permanent magnet assembly (which can also be formed by a poured or cast continuous magnet) configured to exert a magnetic repelling force against the magnetic rotors 130, 131, 140, 141. In an embodiment, the lift assist assembly 160 could set outside the radius 105 but magnetic forces would have to be increased in an inefficient manner to do so. The lift assist assembly 160 is configured to begin lifting the magnetic rotors 130, 131, 140, 141 at just after 6 o'clock and pushing them as far as they will travel into the central hub 150 at about 7 o'clock, so that the opposite end of the rotor is fully extended at about 1 o'clock. In an embodiment, the magnetic rotors 130, 131, 140, 141 will be fully pushed upwards at 1 o'clock and 7 o'clock. FIG. 7A depicts this movement midway through the about 7 o'clock to 1 o'clock sliding event, i.e., sliding of the second magnetic rotor 140 of the first arm 110 into the central hub 150, and the first magnetic rotor 130 being slid to the maximum radius 105. The fully extended position is shown by the second arm 120. As the sliding event occurs the center of gravity of the first arm 110 is moved upward toward the 1 o'clock outer radius 105, increasing the potential energy of the system at a point where both kinetic and potential energy of the first arm 110 are low. The weight of the first arm 110 and first magnetic rotor 130 are able to efficiently impart a high amount of energy to the system 100 when energy is needed most. In an embodiment, the only magnetic influence on the rotational motion of the system 100 is exerted in the area of from 6 o'clock to 8 o'clock, such as 6:01 to 7:15, or 6:05 to 7:00 o'clock, and/or the only magnets acting on the system 100 are in an area around the system 100 of from 6 o'clock to 8 o'clock, such as 6:01 to 7:15, or 6:05 to 7:00 o'clock.

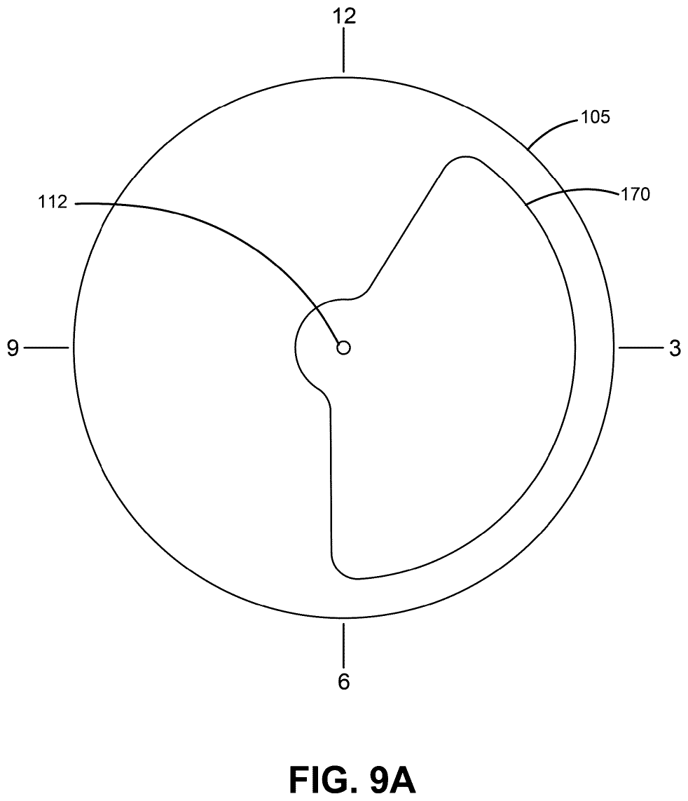

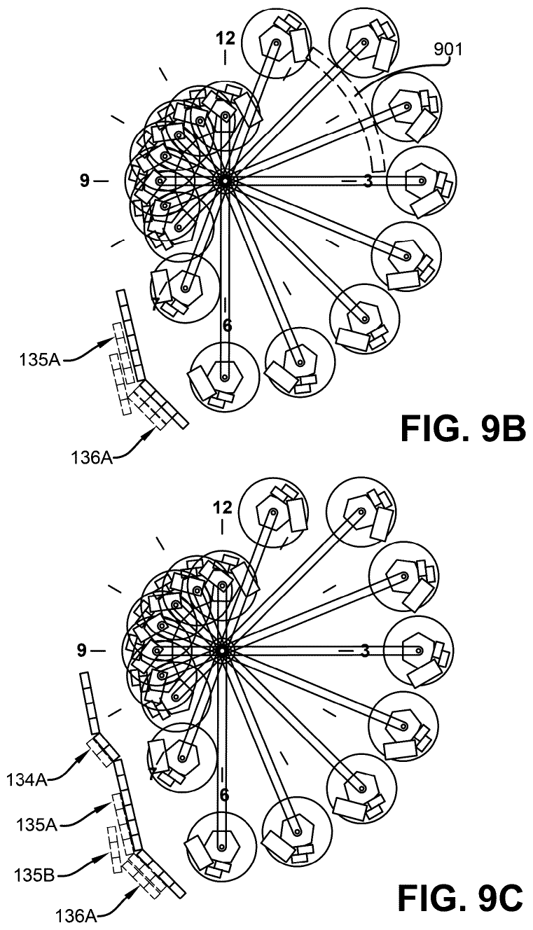

In an embodiment, once first arm 110 has ascended to at or near its full extension at or after 1 o'clock, there could be an upward sloping (i.e., sloping up as it extends toward the axis 112 control cradle for the rotor in the lower left quadrant, (in FIG. 7A second magnetic rotor 140) keeping it as close as possible to axis 112 while extended during 7 to 9 o'clock travel. In an embodiment, at or around 1 to 2 o'clock, (See FIG. 9B) optionally there could be a stand-alone or hanging downward sloping arc (sloping down away from the axis 112) or channel 901 that rotor 130 (or a smaller offset adjoined rotor wheel) can descend onto, ending at 2:55 to 3 o'clock gravity transition. This would help relieve any backward gravity pressure (inertia) on the overall apparatus since the rotor 130 would be rotationally rolling downhill on the arc or channel 901 instead of being pushed up and held in place by forces acting on the axially opposite rotor 140 in area 134 (as in FIGS. 7A and 9C). In an embodiment, a ratcheting or one-way clutch/gear mechanism can be used to hold the arm in the fully extended position from 1 o'clock to 3 o'clock (with the converse portion rolling from 7 o'clock to 9 o'clock). Then as the arm turns past 3 or 6 o'clock, the mechanism releases, allowing the sliding action to take place again. This feature may increase friction in the system 100 though.

In an embodiment, the lift assist assembly 160 has four differently angled areas of stator magnets 164, which could also be a poured magnet to smooth out curves. These are secured to a support, either underneath or on the side, and configured to be at particular angles relative to the axis 112 and magnetic rotors 130, 131, 140, 141.

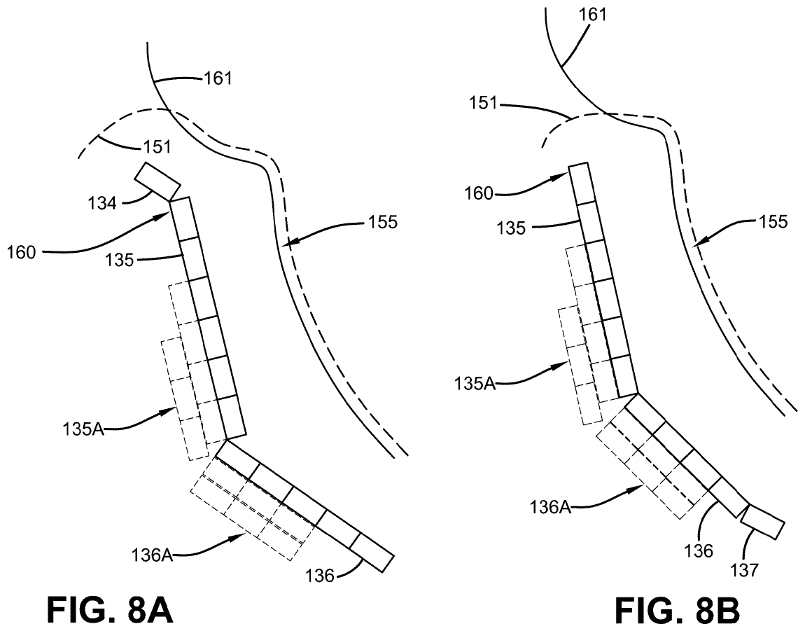

An optional first or “pickup” area 137 (See FIGS. 8A and 8B) is similar to the inner area 37 described above for the embodiment of FIG. 1. In the first area 137, the stator magnet(s) are sloped either downward (as it extends inward toward the axis) at a negative slope or even at an upward at a positive slope, depending on other variables in associated areas above it. In an embodiment, this downward slope is −1 to −6 units (negative meaning dropping) of vertical distance for every 1 unit of horizontal distance (toward the right, or the middle of the wheel 10, such as −2 to −5, or −2.5 to −4.5. In an embodiment, the average angle of the positive or negative slope from horizontal of this first area 137 is 4 to 24 degrees, such as 6 to 18, or 8 to 16 degrees. In an embodiment, the first area 137 may have a curvature with a section that is parabolic, as described by Equation I above. In an embodiment, the first area 137 is not used and the second area 136 performs the gentle pickup function as well as the function of the second area 136 described below.

The second area 136 gently begins the sliding action pushing the arms 110, 120 up towards 12 to 1 o'clock, such as 12:10 to 12:50, or 12:15 to 12:45. In an embodiment, the second area 136 has an overall less negative slope (as it heads to the right) than the first area 137 and the third area 135. In an embodiment, the angle of the third area 135 may be 35 degrees from horizontal, plus or minus 10 or 15 degrees, or 45 degrees from horizontal, plus or minus 5 or 15 degrees.

The third area 135 has a more negative slope (as it heads to the right) than the second area 136 and is generally facing toward 2 to 2:55 o'clock, such as 2:10 to 2:45, or 2:15 to 2:30. In an embodiment, the angle of the third area 135 may be 70 degrees from horizontal, plus or minus 10 or 20 degrees, or 77 degrees from horizontal plus or minus 5 or 15 degrees.

The third area 135 pushes the arms 110, 120 in (toward the axis 112) more strongly than the first area 137, and also intrudes into the radius 105. The magnetic rotors 130, 131, 140, 141, are also being pushed up by the second area 136 stator magnets 164 at least at the beginning of the third area 135.

The fourth area 134 is present in some embodiments and finishes the sliding motion, pushing the arms 110, 120, and magnetic rotors 130, 131, 140, 141 into the central hub 150 and into full extension out to the radius 105. Stator magnets 164 here are angled toward 12:15 to 1:15 o'clock, such as 12:45 to 1:10 o'clock, or 12:55 to 1:05 o'clock. Stacked or stronger magnets may be used in the fourth area 134, such as 2 to 6 times, 2.5 to 5 times, or 2.8 to 3.5 times that of the strength of the magnets in the other areas. In an embodiment, neodymium magnets may be used in the fourth area. Other embodiments may utilize additional one or more magnets in the same or different areas, with the same or different angles, to push or pull the rotors into extended/interior positions. In other embodiments, an arc or channel 901 is utilized for keeping the rotors in extended/interior positions.

It should be understood that the first, second, third, and fourth areas 137, 136, 135, 134 can be longer or shorter configured in accordance with the radius of motion of the rotor head. In an embodiment, there are supplemental magnets 135A and 136A (shown in broken lines) to amplify the field in these areas. This can also be accomplished with stronger magnets in these areas.

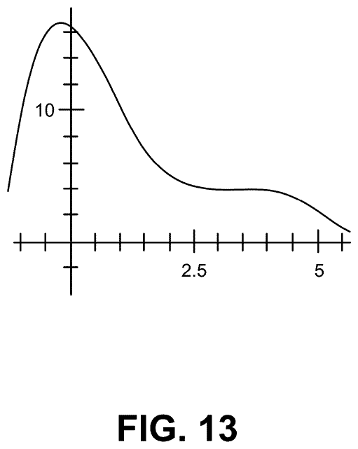

In an embodiment, the top surface of a poured magnet for the first, second, third, and fourth areas 137, 136, 135, 134 can have a curvature with at least three inflection points, one each in the first, second or third, and fourth 137, 136, 135, 134 areas. The general shape of the top surface may, for example, correspond to a cross-section following the shape of the fifth order polynomial y=16.37376−2.678644*x−5.960459*x\hat{ }2+3.416238*x\hat{ }3−0.6577951*x\hat{ }4+0.04238311*x\hat{ }5 (Equation III) in the range of x=0 to 6. FIG. 13 shows an example of this curve. In an embodiment, each of the variables in Equation III may vary −15% to 15%, such as −10% to 10%, or −5% to 5% and/or for any x-coordinate, the y coordinate can vary by −15% to 15%, such as −10% to 10%, or −5% to 5%. In an embodiment, the geometries shown in the figures are described by a curve fit to an equivalent equation with the same variance ranges disclosed above.

To demonstrate the effect of the fourth area 134, FIG. 8A and FIG. 8B depict a zoomed-in view of the motion transfer system 100, wherein the area of the lift assist assembly 160 from an arc extending from about 6 o'clock to about 8 o'clock is shown. In an embodiment, the lift assist assembly 160 may be located in an arc relevant to the axis 112 of just after 6 o'clock to 7 o'clock. An upper magnetic flux line 151 is shown that corresponds to the magnetic rotors 130, 131, 140, 141, as they move into and through the upper area depicted. There is an overlapping area 155 between the lines where the magnetic fields interact and exert a force on the magnetic rotors 130, 131, 140, 141 and the lift assist assembly 160 has four differently angled areas of stator magnets 164 (depicted here as a poured continuous magnet). Line 161 corresponds to a potential wheel path for an associated ramp or control track, which will have little if any friction until at or around the 7 o'clock extension transition. In an embodiment, the arc or channel 901 can aid in maintaining this line 161 of travel.

In an embodiment, the lift assist assembly 160 is configured to smoothly and with as little pushing against the direction of rotation as possible, push the magnetic rotors 130, 131, 140, 141 up and toward the axis 112 in the lower left quadrant with the resulting push out away from the axis 112 into the upper right quadrant. The strength and geometry of the magnets of the lift assist assembly 160 (particularly in the fourth area 134) can be configured to smoothly push and hold the rotors 130, 131, 140, 141 near the axis 112 in the lower left quadrant. At or just after 3 o'clock there is a gravity transition (meaning that their travel will be determined by gravity) of the magnetic rotors 130, 131, 140, 141 just as their potential energy is optionally strategically amplified in the third and fourth areas 135, 134. An extended (elongated) area 134 as depicted in FIG. 9B may be used in concert with ramp 901, as longer shafts necessitate longer travel time through a given arc. Axiomatically, the longer and/or heavier the shaft at or around a 1 to 3 o'clock extension, the greater the energy in the system.

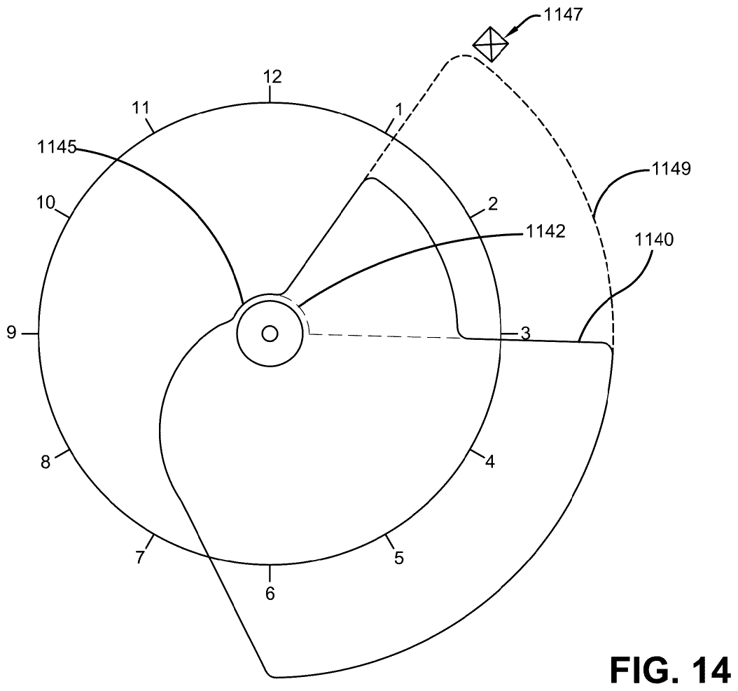

In an embodiment, as shown in FIG. 8B, without the additional fourth area 134, the magnetic rotors 130, 131, 140, 141, may not be pushed sufficiently to fully engage and keep the affected magnetic rotors 130, 131, 140, 141 pushed into the central hub 150 until at least the 9 o'clock position, and pushed out to the radius 105 on the other side. To solve a potential problem with configurations of FIG. 8B, FIG. 8A, in contrast, shows the stronger magnetic push from the fourth area 134 toward the 1 o'clock and after position. In this embodiment if extended further (as illustrated also in FIGS. 9B and 14), the magnetic rotors 130, 131, 140, 141 will be sufficiently held into place long enough for the rotational motion of the system 100 to carry them out from about 6 o'clock area to about 9 o'clock area, at which the sliding movement has positioned the magnetic rotors 130, 131, 140, 141 into a position where gravity will propel the wheel. A one-way ratchet mechanism coupled with an arced cradle/ramp after about 7 o'clock to about 9 o'clock can also keep the magnetic rotors pushed into place near the axis 112 in the lower left quadrant, with resulting friction being offset by the opposite extended longer lever gravity assist. In another embodiment, the third area 135 is angularly extended to keep the rotors 130, 131, 140, 141 sufficiently pushed in to the axis 112.

FIG. 9A is a diagram with a line 170 tracing movement of a center point of the rotor magnet, e.g., 130, as it progresses around the axis 112 of the system 100. The radius 105 indicates the outer edge of the travel of the magnetic rotor 130. FIG. 9B shows a detailed view of the rotor head in motion around the circle.

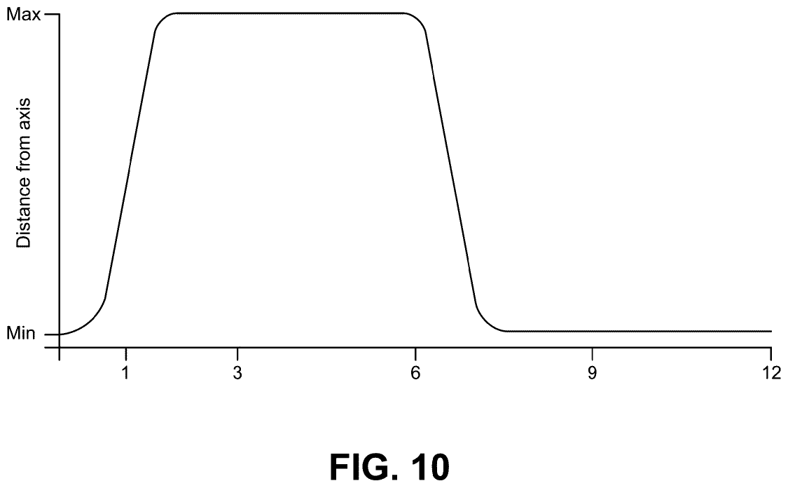

FIG. 10 is a graph showing the distance of a single rotor magnet, e.g., 130, from the axis 112 on the y-axis, as it travels around the circle on the x-axis. This provides another visualization of the operation of the system 100.

As can be seen in FIGS. 9 and 10, and further generalized for broader disclosure, at 1 o'clock the magnet rotor 130 is at its maximum extension. This could happen anywhere from just after 12, e.g., from 12:00 to 1:30 o'clock, e.g. 12:15 to 1:15 o'clock, 12:45 to 1:10 o'clock, or 12:55 to 1:05 o'clock. The magnetic rotor 130 stays extended at the maximum extension until just after 6 o'clock, where the magnetic rotor 130 encounters the magnetic field of the lift assist assembly 160. Just after 6 o'clock, the ascent is at first gradual, then accelerates and quickly is moved into the minimum distance from the axis 112 position. This inward sliding movement happens from just after 6, e.g., from 6:00 to 7:30 o'clock, e.g. 6:15 to 7:15 o'clock, 6:45 to 7:10 o'clock, or 6:55 to 7:05 o'clock. Once pushed to the minimum distance from the axis 112, the magnetic rotor 130 stays at this radius until it reaches approximately 12 o'clock and the movement repeats.

The system 100 can also have additional sliding arms, e.g. 3 to 1000, 4 to 100, or 5 to 10. By extending the system axially and adding additional rotors and stators, additional scale can be gained. In an embodiment, the sliding arms can have a telescoping mechanism. For example, the telescoping mechanism can allow extension of the ends of the sliding arms to a radial distance even further (e.g., 1 to 2 times) than the opposite end retracts toward the axis 112. The length of the arms can vary, to a distance of, e.g., 0.1 mm to 200 meters, such as, for example 1 mm to 1 meters, 10 mm to 1 meter, or 0.5 meters to 50 meters, whether telescoping or not.

In an embodiment (with rotational movement dynamics shown in FIG. 14), an arm can be used in conjunction with a lift assist that only lifts the arm part way, and then just after 3 o'clock the rotor extends fully. In an embodiment this can be extended to a two-stage lift assist embodiment. FIG. 14 shows the line of movement 1140 of a magnetic rotor in such embodiments. For example, in a telescoping embodiment with a two-stage embodiment, a lift assist assembly such as those disclosed herein, or modified to match the rotation lines of FIG. 14, can be utilized to push the telescoping arm in radially towards the axis 112 to put the magnetic rotor in a first stage tucked-in position and move it along its trajectory until it reaches just after 9 o'clock where the magnetic rotor is free to slide inward by force of gravity to its axially innermost position 1145. The magnetic rotor travels along the line of movement 1140 until it reaches just after 1 o'clock, where, in an embodiment, a pulling magnet 1147 (which may be electromagnetic and subject to a timed pulse when the rotor reaches the just prior to 1 o'clock position) pulls the magnetic rotor up towards 1 o'clock, or in an embodiment, the pulling magnet can be configured to pull the magnetic rotor towards 3 o'clock. In an alternate embodiment, the magnet follows an alternate line of motion 1142 without the involvement of the pulling magnet. This alternate line of motion 1142 is driven by gravity as the rotation tips down and the rotor simply slides all the way out just after 3 due to gravity.

The two-stage embodiment has the advantage of increasing the torque on the system from about 3 o'clock to about 6 o'clock compared to the system of FIGS. 7A-9C with the additional pulling magnet 1147, or at least from about 3 o'clock to about 6 o'clock without the addition of the pulling magnet 1147. In another embodiment, the second stage could be extended to gain additional torque even before 3 o'clock, such as, e.g., at 1:00 to 3:00 o'clock, e.g., 1:30 to 2:30 o'clock. This could involve, e.g., a pulling magnet 1147 located somewhere in the 1:00 to 3:00 o'clock area around the circumference of the system, e.g. 1:15 to 2:15, or 1:30 to 2:00, or some other input to the system to enhance the pulling of the telescoping arm to its full extension. This pulling magnet 1147 should be placed to urge the magnetic rotor out toward the maximum circumference of the rotation without catching the rotor in its magnetic influence and braking the system. A pulling magnet is used in this embodiment, since it can be difficult to achieve more than about 6 inches of pushing influence with permanent magnets. A spring-loaded telescoping mechanism could also be utilized in a telescoping embodiment, in which a spring within or exterior to the arm is compressed when pushed in on the left side of the rotation and naturally released when out of the magnetic field, which could continue to urge the rotor in until 12:00 o'clock or later. In another embodiment, the spring can be compressed and held by e.g., a ratchet mechanism, and released at an opportune time after 12 o'clock, e.g., from 12:30 to 2 o'clock, or 1:00 to 1:30 o'clock. As the mechanism rotates, it could trigger a lever to release the ratchet mechanism allowing the spring to be released and the telescoping arm to extend fully.

The telescoping mechanism itself can be implemented as a shaft within a hollow shaft slidably coupled with ball bearings or rollers, e.g., a sliding drawer mechanism.

The second lift assist assembly provides the majority of the lift assistance on the magnetic rotor of the partially extended shaft or the tucked in telescoping arm. In this configuration the first lift assembly is lower and earlier in the rotation than the second lift assist assembly.

FIG. 9C shows a detailed view of a rotor head in motion around the circle in an embodiment of a two-stage system. Note that the second stage stator magnets are inclined similarly but shorter than the first stage stator magnets. The area between the two inclined portions of the second stage may encourage a slight retraction of the rotor head, but a mechanical mechanism, such as a one-way clutch mechanism may prevent the rotor head from falling back at this point. Alternatively, a non-magnetic physical barrier (e.g. a wall) that blocks the rotor head from falling back may prevent such falling back as well.

In another embodiment, the rotation of a two-stage lift assist with a telescoping arm system is shown in FIG. 14 in broken lines. In this embodiment, the influence of the pulling magnet 1147 or some other mechanism extends to, e.g., 1 o'clock to 2 o'clock, or even further to 3 o'clock, pulling (or pushing) the telescoping arm out to its full extent at 1 o'clock to 2 o'clock, or even 3 o'clock. If magnetic or other forces are not applied once the full extension is reached, a one-way clutch mechanism can keep it from retracting at this point. The one-way clutch would be released by a mechanism prior to the push-up that occurs at the bottom of the circular travel motion. In an embodiment, the telescoping arm may reach out a maximum of, for example 18 to 72 inches from the axis, such as, 24 to 54 inches, or 22 inches to 36 inches. Without telescoping, the arm may reach out for example, 3 to 24 inches from the axis, such as, 6 to 18 inches, or 8 inches to 12 inches. Once the telescoping rotor is out at 2 o'clock, it should be substantially easier to hold in the opposite rotor from 8-9 o'clock near the axis since the vast majority of the mass is out and torquing with a gravity assist downward. Broken line 1149 shows the outward telescoping movement extending fully at about 2:00 on the right side of the FIG. 14 in this embodiment.

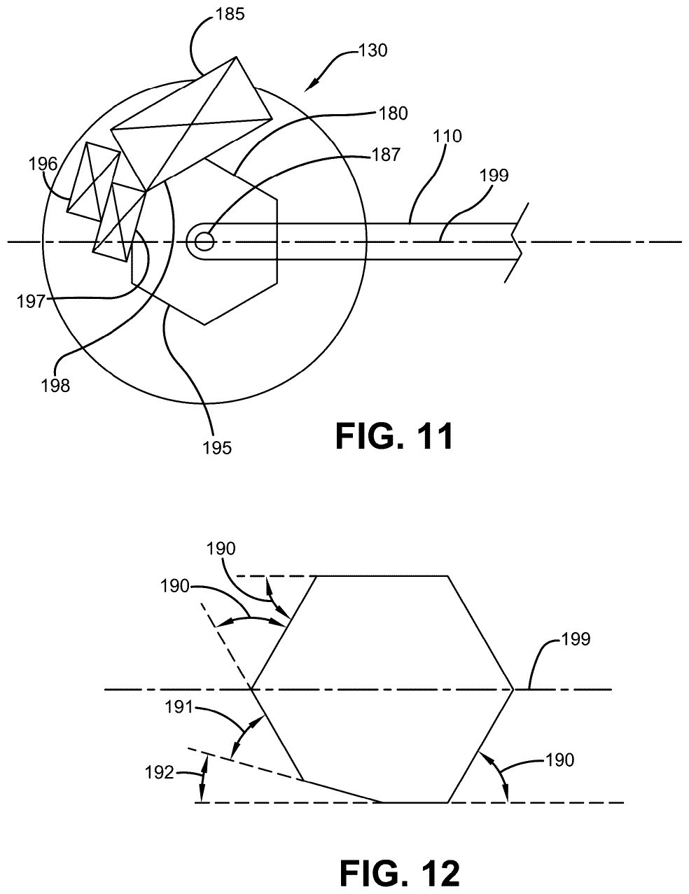

FIG. 11 is a cross-sectional and zoomed-in view of an embodiment showing an end of the first arm 110 detailing the magnetic rotor 130. In an embodiment, each of the magnetic rotors 131, 140, 141 can also have this construction. The magnetic rotor 130 in this embodiment includes three magnets, a front magnet 197, a rear magnet 185, and a second front magnet 196, each of which generally face away from the axis 112 (see FIG. 7A). The first arm 110 is coupled by mechanical connectors and/or adhesive to keep the rotor head 180 from moving. The front and rear magnets 197, 185 are also coupled to the rotor head 180 by mechanical connectors or an adhesive. In an embodiment, the device of FIG. 11 has a screw connecting the front, rear, and second front magnets 197, 185, 196 to the rotor head 180 and a pin or screw 187 extends through a hole in and is connected to the rotor head 180. In an embodiment, the second front magnet 196, stacked on top of the front magnet 197 is not present. In an embodiment, the front, rear and second front magnets are fixed to the rotor head 180 and do not change orientation in relation to the rotor head 180.

The rotor head 180 can be made of a non-magnetic or weakly magnetic metal, such as anti- or non-ferromagnetic materials, e.g., copper, graphene, aluminum, stainless steel, brass, composites, plastics, or polymers, such as, DELRIN, nylon, polyamide-containing polymers (with Mn over 500,000 g/mol to 1,000,000 g/mol), acetal plastic, or polycarbonate. As shown best in FIG. 12, the rotor head 180 can be machined to be essentially a hexagon, with 30-degree exterior angles (e.g. 190), except for one truncated corner, where a 15-degree angle 192 and 45-degree angle 191 are formed, converting the hexagon into an irregular heptagon. The size of the rotor head 180 can scale with the rest of the system and its various applications, and can be e.g., 0.01 mm in diameter to 5 m in diameter, such as, 1 mm to 1 m, or 10 mm to 100 mm.

The front magnet 197 can be toroidal or with a round or polygonal shape mounted at the outer leading edge 195 of the magnetic rotor 130. It can be mounted, for example, at a 10 to 50 degree angle relative to the long axis 199 of the first arm 110, such as 10 degree to 45 degrees, or 15 degrees to 25 degrees. The outer leading edge 195 of the magnetic rotor 130 may be on a regular 60 degree hexagonal angle as shown in FIG. 12, plus or minus 20 degrees, or 10 degrees, which is the same angle with respect to the long axis 199 of the first arm 110.

The rear magnet 185 is mounted on the trailing edge 198 of the magnetic rotor 130, and its outer face is oriented in the direction of the face of the trailing edge 198, which may be on a 45-degree angle as shown in FIG. 12, plus or minus 20 degrees, or 10 degrees, which is the same angle with respect to the long axis 199 of the first arm 110. The rear magnet 185 is configured to interact strongly with the fourth area 134 (see FIG. 8A) to give a final push up and towards the axis 112 as the magnetic rotor 130 moves out of the influence of the lift assist assembly.

In an embodiment, multiple magnets are not needed, and a single shaped magnet can be used instead. A toroidal magnet with a rounded (side) or flat (bottom) surface facing to the outside (radial) direction may be used in an embodiment.

The types of magnets used herein may be selected along with the parameters of the system. As used herein, the term magnet is used for objects that produce a persistent magnetic field even in the absence of an applied magnetic field. This includes ferromagnetic and ferrimagnetic materials.

Ceramic, or ferrite, magnets are made of a sintered composite of powdered iron oxide and barium/strontium carbonate ceramic. These magnets are non-corroding but brittle and must be treated like other ceramics. Alnico magnets are made by casting or sintering a combination of aluminum, nickel and cobalt with iron and small amounts of other elements added to enhance the properties of the magnet. Sintering offers superior mechanical characteristics, whereas casting delivers higher magnetic fields and allows for the design of intricate shapes.

Injection-molded magnets are a composite of various types of resin and magnetic powders, allowing parts of complex shapes to be manufactured by injection molding. The physical and magnetic properties of the product depend on the raw materials, but are generally lower in magnetic strength and resemble plastics in their physical properties.

Flexible magnets are composed of a high-coercivity ferromagnetic compound (usually ferric oxide) mixed with a plastic binder. These can be extruded as a sheet and passed over a line of powerful cylindrical permanent magnets.

Rare earth metals of the lanthanum series have a partially occupied f electron shell (which can accommodate up to 14 electrons). The spin of these electrons can be aligned, resulting in very strong magnetic fields, and therefore, these elements are used in compact high-strength magnets where their higher price is not a concern. Examples of these types of rare-earth magnets are samarium-cobalt and neodymium-iron-boron (NIB) magnets.

Very recent advances have been made in mining and processing rare earth neodymium magnets. A new method of sintering neodymium magnet material developed by NITTO DENKO exploits an “organic/inorganic hybrid technology” to form a clay-like mixture that can be fashioned into various shapes. Through this process, control a non-uniform orientation of the magnetic field in the sintered material can be leveraged to locally concentrate the field. This can improve the performance of the devices disclosed herein and increase efficiency even further.

In a method for transferring motion, steps include: applying a starting force to begin rotation of a magnetic rotor rotating vertically on a horizontal axis; and applying a magnetic repelling force against the magnetic rotor in at least a portion of an arc of the rotation including 6 to 9 o'clock, such as 6 to 7 o'clock, or ranges mentioned above. Then the rotational motion can be converted to other motion or energy can be extracted from the rotation of the magnetic rotor.

Energy can be supplied to the system to begin or maintain motion other than through the permanent magnets by various methods, for example, falling water (such as through a waterwheel), wind power (such as through a windmill), solar, steam, electric, pneumatic, manual, heat (e.g., Stirling engine, fossil fuel combustion), or nuclear power.

Each of the motion transfer devices disclosed above can be used to transfer rotational motion, and various mechanical devices can be used convert into a desired directional motion. Energy can be extracted and used or stored from the systems disclosed herein by, for example, steam generation, heat generation, flywheel energy storage, electric energy, such as generated by current induced from moving the rotor magnets through a wire coil, and batteries to store the energy.

In various embodiments, weight and RPM of the rotor can influence the operation of the device and the energy input and output. In an embodiment, the rotating mass can be a store of energy. The rotating mass eventually either returns energy to the system, or something converts the stored energy to some other form of energy. The conversion might be with a friction source, converting to heat energy. Eddy current could be induced by applying conductors in the magnetic field of the rotating magnets to the side or periphery of the rotating magnets, thereby providing direct electrical power output. Optimum placing of such can be done with reference to Faraday's law. The energy output could be stored and could be used, e.g., for the smoothing of cylinder pulses in an engine flywheel.

In an embodiment, a large-scale windmill coupled to a power grid could utilize the systems disclosed herein. The windmill could be placed near an earthen hill (man-made or natural), where the stator magnets would be placed on the earthen structure, a man-made scaffolding structure, and/or a combination thereof using prefabricated materials. The rotors or wheel could be aerodynamically configured, e.g., by adding angled blades, to be moved by prevailing winds. A side reinforcement could also be located on the slope or a substructure to connect to the windmill tower at an angle to stabilize it further against any additional forces caused by the sliding rotors of one of the embodiments disclosed herein.

In an embodiment, a lift assist system as described herein can be applied to a crankshaft in an engine cylinder. In particular, it can be applied at the bottom of the cylinder and assist the crankshaft in moving up in its rotational cycle. Variable timing controlled for example by a vehicle engine control unit can be applied to, e.g., electromagnetic pulses, or magnetic blockers (to block permanent magnets), or ratchet catch and release mechanisms can be utilized to further enhance timing of the systems disclosed herein.

If the permanent magnets are too strong, this could cause too much force pushing on the magnetic rotors. Doing more than is necessary in a direction that does not support the rotation will cause unneeded friction against this axis of rotation and/or for the second embodiment, unneeded (unbalanced) vibration, or instability.

In an embodiment, a Halbach array (see U.S. Pat. No. 6,664,880, incorporated herein by reference) can be used to improve the magnetic field effect of the systems described above. A Halbach array is a special arrangement of permanent magnets that augments the magnetic field on one side of the array while cancelling the field to near zero on the other side. The field is twice as large on the side on which the flux is confined (in the idealized case). There is no stray field produced (in the ideal case) on the opposite side. This helps with field confinement.

A Halbach array is achieved by having a spatially rotating pattern of magnetization. This is done by lining up magnets in a magnetization pattern where the components of magnetization are π/2 out of phase with each other (or 90 degrees). Thus, a series of magnets arranged linearly and each successive magnet field being oriented 90 degrees in the same direction (e.g., clockwise) from the previous magnet's field presents a Halbach array.

In an embodiment, air can be pumped out of the vicinity of the system to eliminate air drag further increasing efficiency of the system. In embodiment, the pressure in the system may be very low, but non-zero, such as 1.0×10⁻¹⁷ torr to 25 torr, 1.0×10⁻⁹ to 1.0×10⁻¹, or 0.001 to 1 torr.

In an embodiment, the systems disclosed herein can be integrated with an electromagnetic suspension system or an electrodynamic suspension system to reduce friction along the range of motion of the system. In an embodiment, electromagnetic propulsion coils or another type of magnetic linear motor can be added to maintain motion, such as to maintain motion at a constant or desired velocity. In an embodiment, these principles can be used to provide a magnetic bearing for rotation or keep the moving parts in a magnetic field to reduce friction. In an embodiment, electromagnetic propulsion can be used to impart sufficient energy and motion to reach peak vertical height. This is distinct from the permanent magnets disclosed in the lift assist assemblies and magnetic rotors disclosed above.

In an embodiment, one or two sets of magnets operate in coordination to provide extremely low friction movement. A first set disposed in a static track, e.g., housed in the central hub 150, repels the moveable object, e.g., a rotor, against gravity and the walls of the hub 150, and is configured to hold it in a stable hovering state for low friction movement. A second set is configured in a manner to move the object along the track, e.g., with electromagnetic control to reverse directions and fine-tune timing of sliding events in the system as needed. The second set can be coupled to the moving object (rotor) or the static track e.g., hub 150, on or along the track.

A brief/timed electrical or electromagnetic pulse/surge (or another form of energy, e.g., combustion, pneumatic, hydraulic, hydrogen, steam, fluid/waterjet, sonic, nuclear or otherwise hybrid power boosted) at strategic sections, e.g., a pulling force at 12:01 to 2 o'clock, to pull the arm up could allow for even greater weights to be carried by the arms of the system or greater radii to be traversed by the arms of the system. Hybrid power may include eddy current generated from the movement of the magnets through the system and then the stored energy is applied in a quick pulse as, for example, an electromagnetic pull in a strategic section to further the travel motion of the system. These enhancements could provide a superior mechanical advantage, improving the power to weight ratio of the system (more torque or power with less overall weight).

In other embodiments, the technology disclosed herein can be applied to flywheel, gear, turbine, planetary/epicyclic or sun and planet gear/system, sprocket, pulley, gyroscope, cam, or crankshaft counterweight devices.

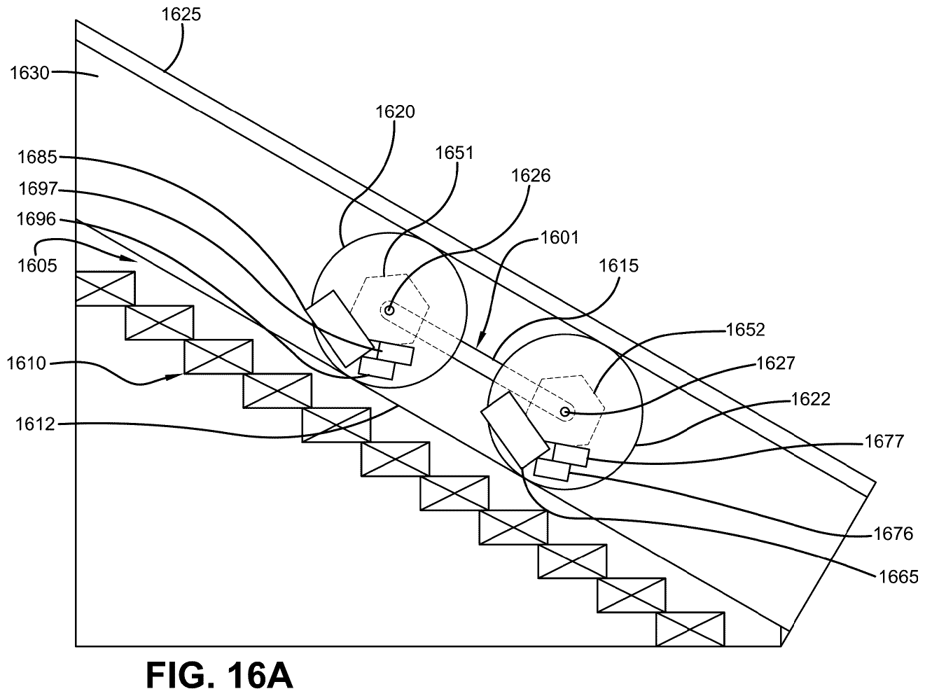

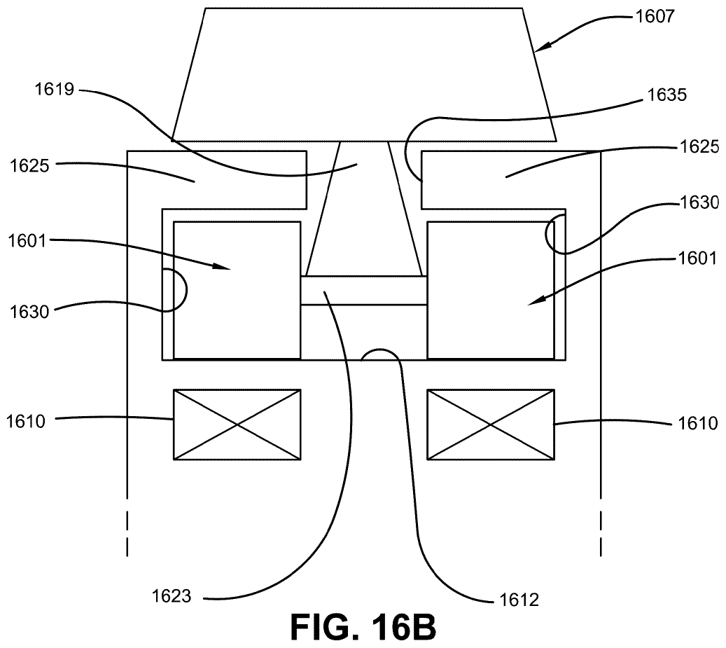

In an embodiment of a travel system, as depicted, for example, in FIG. 16, one can push, pull, propel and/or drive to create a magnetically supported set of spinning wheels providing mechanical advantage up an inclined slope/ramp to lift assist in overcoming forces of gravity and friction.

FIG. 16A discloses a wheeled ramp vehicle 1601 and a ramp 1605 with the stator magnets 1610 oriented with their poles on a horizontally level plane and their edges abutting or very closely spaced to each other (e.g. 0.00001 to 5 mm apart, such as 0.0001 to 0.1 mm apart). The stator magnets 1610 are successively placed in a series along a diagonal, rising higher consistent with the incline of the ramp 1605, i.e., approximately parallel to the ramp surface 1612, e.g., plus or minus 10%, or plus or minus 5%, the percentage being calculated as an angle deviation from parallel divided by 90 degrees. In embodiments, the stator magnets 1610 may be plus or minus 20% parallel with the ramp 1605. Corners of the stator magnets 1610 can be touching as shown, or may overlap or be spaced apart horizontally and slightly e.g., by 0.001% to 20%, 0.1% to 10%, or 1% to 5% (based on their total lengths in the x-axis). The stator magnets 1610 are disposed under the ramp surface 1612, which is smooth.

A roof 1625 is over a portion of the wheeled ramp vehicle 1601. The roof 1625 may be coupled to the ramp 1605 through a sidewall 1630. The roof 1625 serves to hold the wheeled ramp vehicle in magnetic communication with the ramp 1605. In some embodiments a roof 1625 can be omitted, e.g., if the wheeled ramp vehicle 1601 is sufficiently held to the track and at least 3 wheels are present for lateral balance and support. The arrangement is designed to minimize friction by constructing an undulating magnetic flux on which the ramp vehicle 1601 can travel across and when at a minimal speed, mainly hit the high points of the undulating surface. This was experimentally determined to be energetically advantageous (see Examples below). The concept is akin to sliding an object up a ramp, versus sliding it up stairs, where the object is long enough to hit at least two of the vertices of the stairs. There is less friction to slide the object up the stairs than there is in sliding up a ramp.

Stator magnets 1610 are configured to interact with, i.e., be placed in proximity to and in range of the magnetic field of the magnets on the first and second wheels 1620, 1622 of the ramp vehicle 1601. In the embodiment shown, the stator magnets 1610 are oriented with a pole facing upward. The first and second wheels 1620, 1622 are configured to have a wheel surface that contacts the ramp surface 1612. The “wheel magnets” are fixed facing generally downward to oppose the poles of the stator magnets 1610. By repelling the stator magnets 1610, one or more wheel magnets are configured to lessen the weight of the ramp vehicle 1601 on the ramp surface 1612. The wheel magnets comprise the magnets on the first and second wheels 1620, 1622, and these may be the same or similar to the rotors of FIG. 11 (130). In particular the first wheel 1620 includes a front magnet 1697, a second front magnet, 1696 and a rear magnet 1685. These are disposed, for example, on the hub 1651 in the geometries disclosed in FIGS. 11 and 12. Briefly, the front magnet 1697 and second front magnet 1696, stacked with at least partial overlap, and face (i.e., the poles face) the same direction. The rear magnet 1685 is adjacent and to the clockwise side of the front magnet 1697 and second front magnet 1696. The rear magnet 1685 faces a different direction (i.e., the pole faces a different direction) than the front magnet 1697 and second front magnet 1696. This different angle may be about 45 degrees different, or from 15 to 60 degrees, such as 20 to 50 degrees, or 40 to 50 degrees. The magnets on the second wheel 1622 (front magnet 1677, a second front magnet 1676 and a rear magnet 1665) are configured the same as the first wheel 1620.

A connecting arm 1615 couples the first wheel 1620 and second wheel 1622, via a first axis 1626 and a second axis 1627. A first hub 1651 and second hub 1652 house the axle and are coupled to the wheel magnets 1685, 1696, 1697, 1665, 1676, 1677. In an embodiment, one or more connecting arms 1615 or another coupling structure attaches three, four, or more wheels (e.g., wheels sufficient for bilateral symmetry-balance) to form the magnetic wheeled ramp vehicle 1601 for movement along the inclined ramp 1605.

In another embodiment, the same or similar wheel with magnets all around may be used as in FIG. 1 (14) as the first or second wheels 1620, 1622. Additionally, the lift assist assembly 20 in FIGS. 1 & 2 are implemented in a different way versus the stator magnets 1610 of FIG. 16A, as ultimately the same “push up” principles in lift assist assembly 20 are superior to just a solid magnetic slope akin to any of the flat float (electromagnetic, Halbach array, or otherwise) configurations or maglev train rail systems that the lift assist assembly would have to “plow” through instead of “hop”, “skip” or “spin step” up on an easier angular plane versus full weight and the resulting friction and gravity. In essence this means that the ramp 1605 by way of the magnetic arrangements as shown and described effectively lessen the weight of the ramp vehicle 1601 and provide a smooth if somewhat undulating skip or hop up the magnetic flux of the stator magnets 1610 of the ramp 1605.

As shown in FIG. 16B, as the scale and work required necessitates, in an embodiment the wheeled ramp vehicle 1601 includes two sets of wheeled ramp vehicles 1601 that are both coupled to a carriage 1607 that extends above the roof 1625 via a vertical connector 1619 through a channel in the roof 1625. The sets of wheeled ramp vehicles 1601 are coupled by a horizontal connector 1623. A portion of the wheeled ramp vehicle 1601 is under a roof 1625 on each side of the channel 1635 in the roof 1625. The roof 1625 may include stator magnets 1610 behind the ramp surface 1612, that may be configured in an orientation to promote rotation of the wheels 1620, 1622, or the roof may contact a flat portion of the top side of the ramp vehicle 1601 or one or more additional wheels on the top side of the ramp vehicle 1601, so as to promote less friction as the ramp vehicle 1601 moves upward along the ramp 1605. In an embodiment, the roof 1625 is configured to keep the one or more magnets on the wheels 1620, 1622 in the influence of a magnetic field of one or more stator magnets 1610. The carriage 1607 may hold, for example, passengers or cargo. In another embodiment, the ramp vehicle 1601 is a part of a larger machine, and is used to promote upward or diagonal motion in the machine.

The inclined slope or ramp (e.g., 30+/−10, 45+/−10, 15+/−10 degrees) embodiment, utilizes similar principles disclosed for the rotary motion embodiments of FIGS. 1-14, in a lineal embodiment. It is an improvement over prior lineal systems (whether pure N-S Mag-Lev or Halbach Array or electromagnetic push/pull-pulse). Instead of having to potentially plow through a magnetic field, the device of FIGS. 16A and 16B steps (magnetically rolls) up a series of mini-ramps/steps (essentially inclined waves) with significantly less magnetic friction.

In an embodiment the ideal slope for a push-pull force inclined ramp was determined to be about 30 or 33 degrees, which was determined with trial-and-error to be superior to 45 degrees (akin to 10:30 or 1:30).

In an embodiment, one or more of the first and second wheels 1620, 1622 can be releasably coupled to a reverse gear and wheel mechanism. The first and/or second wheel can be removed from contact with the ramp surface 1612, and a reverse wheel can be put into contact with the ramp surface 1612. The first and second wheels 1620, 1622 still spin, but this motion is translated though gears to a reverse wheel, which upon contact with the ramp surface 1612 causes the wheeled ramp vehicle 1601 to be driven in a reverse direction. The ramp vehicle 1601 will roll downhill with a gravity assisted minimized effort as opposed to an incline or even a flat surface. A flywheel could also be used to store the energy accumulated from the downhill travel.

In another embodiment, the technology disclosed herein incorporates a rebounding lift assist assembly for a vertical drop piston and dual wheel design (optionally without any comingled/meshed gears). A single-wheel embodiment can also be utilized. In an embodiment, the lift assist assembly can have a one-way clutch gear associated with a drive-crankshaft for gear-trained power amplification-generation.

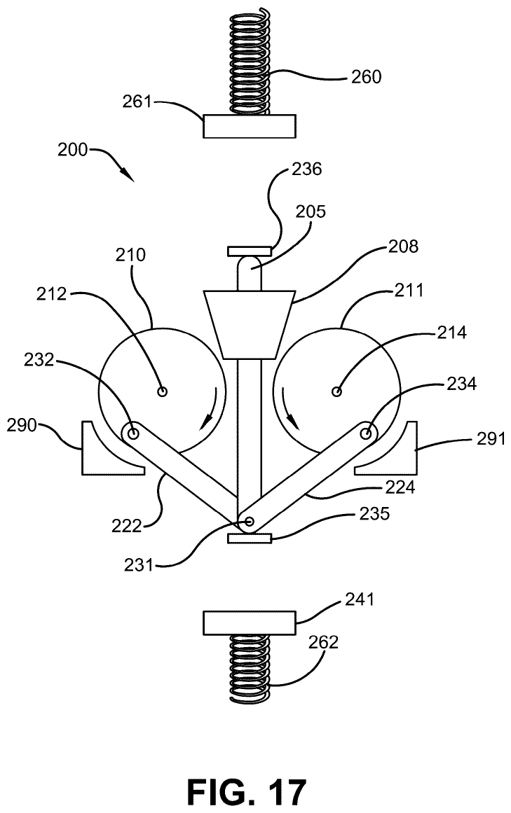

FIG. 17 shows an embodiment of a motion transfer system 200 illustrating some of these principles. Here, a piston arm (aka rod) 205 is coupled to a first wheel 210 and second wheel 211, i.e., two driving wheels, akin to a locomotive drive mechanism. The first and second wheels 210, 211 rotate about an axis 212, 214. The wheels 210, 211 are coupled to a lower end of the piston arm 205 by first and second coupling arms 222, 224 (aka coupling or connecting rods). A mechanical coupling 231 that allows at least partial rotation joins the coupling arms 222, 224 to the piston arm 205. This may be, as shown, a pin extending through the first and second coupling arms 222, 224, and the piston arm 205. A mechanical coupling 232, 234 that allows full rotation joins the coupling arms 222, 224 at their outer ends to the wheels 210, 211. The first and second coupling arms 222, 224 are attached to the first and second wheels 210, 211 at location on the outer portion of the first and second wheels 210, 211

In an embodiment, a lift assist mechanism 290, 291 as disclosed above can optionally be used on each of the outer (and opposite) bottom corners of the wheels 210, 211, to impart lifting force to the encourage rotation of the wheels 210, 211 of the system 200. In another embodiment, the sliding arm rotation system of the motion transfer system 100 (mentioned above) with a matching lift assist assembly 160 can be used in place of or in conjunction with the wheels 210, 211 disclosed in FIG. 17. For example, in the embodiment, the wheels 210, 211 need not include magnets, but rather have the same coupling arms 222, 224 on their outer periphery, but are coupled to a hub for the sliding arm rotation system of the motion transfer system 100.

At the bottom of the piston arm 205 a first piston magnet 235 is secured. The first piston magnet 235 may also be coupled to another location on the piston 205. This piston magnet 235 interacts with a rebound magnet 241 centered under the piston magnet 235 and separately secured to a base. The rebound magnet 241 is aligned with the bottom vertical position of the piston magnet 235 and the piston magnet 235 and rebound magnet 241 are configured with the same pole facing each other for repulsion. At the bottom end of the piston stroke, magnetic fields of the piston magnet 235 and rebound magnet 241 repel and push the magnet 235 and piston arm 205 up. In this embodiment, the rebound magnet 241 is coupled to a spring 262. The spring 262 may be coupled and extend underneath the rebound magnet 241 as shown, but other configurations are also possible with the spring extending sideways or even suspended above the rebound magnet 241. When the rebound spring 262 is compressed by motion of the piston arm 205 and attached piston magnet 235 down, the resulting kinetic energy coupled with the magnetic repulsion between the optimally spaced piston magnet 235 and rebound magnet 241 will result in a rebound force pushing up on the piston arm 205/piston magnet 235.

The spring 262 is optional, as there will be some upward rebound force just from the magnetic field repulsion from even a stationary rebound magnet 241. The spring 262 or other springs disclosed herein, can be a metallic or composite spring, and can be a coil spring, volute spring, hollow tubing spring, arc spring, or a leaf spring. In other embodiments the spring, can be replaced with another type of rebound mechanism, such as a pneumatic compressor spring, an elastomeric band, a magnetic spring, or some other absorber/discharger of energy. In an embodiment the spring other rebound mechanism can be tunable to adjust timing of the oscillations of the system, to the effect that the spring 262 is tuned to be in place after a pushing event when the piston magnet 235 comes back on its downward stroke. The springs disclosed in FIGS. 17-19B can be housed in a control chamber to focus the force vertically.

As described above, the piston arm 205, which can be comingled-conjoined with gears and/or weighted, as joined to the first and second wheels 210, 211 can then be brought back up to its “ready” kinetic start position by both the associated magnetic lift assist as well as the “free” energy from the magnetic repulsion at the bottom coupled with an industrial spring-loaded push up. One or more of the above concepts relating to rotary lift assist assemblies 20, 160 can also be incorporated to act on the rotating gears.

In an embodiment, at the top end of the piston arm 205 a second piston magnet 236 is attached and above the top end of the piston arm 205 a second spring 260 is separately anchored with a second rebound magnet 261 disposed thereon. The second spring 260, second piston magnet 236, and second rebound magnet 261 are all optional. In an embodiment it is efficient that the rebound magnet 241 and second rebound magnet 261 are of approximately equal, e.g., plus within 5% or 10% size and/or strength.

The piston arm 205 is held in generally upright alignment while allowing for angled up and down movement. As shown the piston arm 205 is secured in piston arm stabilizer bracket 208, allowing for the approximately vertical, but optionally angled, up-and-down motion of the piston arm 205. Other mechanisms, such as a pin in channel, could also be used to allowed for the same type of movement keeping the piston aligned in a track for linear motion.

In an embodiment, a one-way clutch and/or gear mechanism can be coupled to the wheels 210, 211 or the piston arm 205, and can be used to prevent unwanted backwards rotation. The one-way clutch or other mechanism for allowing one-way rotation and preventing opposite direction rotation is utilized in the embodiments disclosed below.

In an embodiment, additional weight can be added to piston arm 205 to provide additional downward force, as well as counterweights for wheels 210, 211. The piston arm 205, first wheel 210, and/or second wheel 211 can be coupled to one or more pulleys, linkage, lever, or gear to transfer energy out of the system 200. In an embodiment, a flywheel may be coupled to the system to store energy.

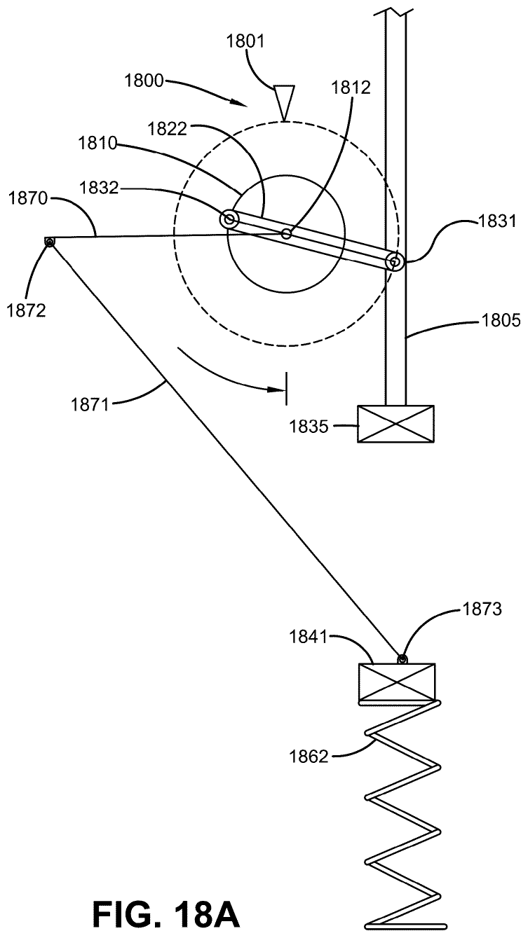

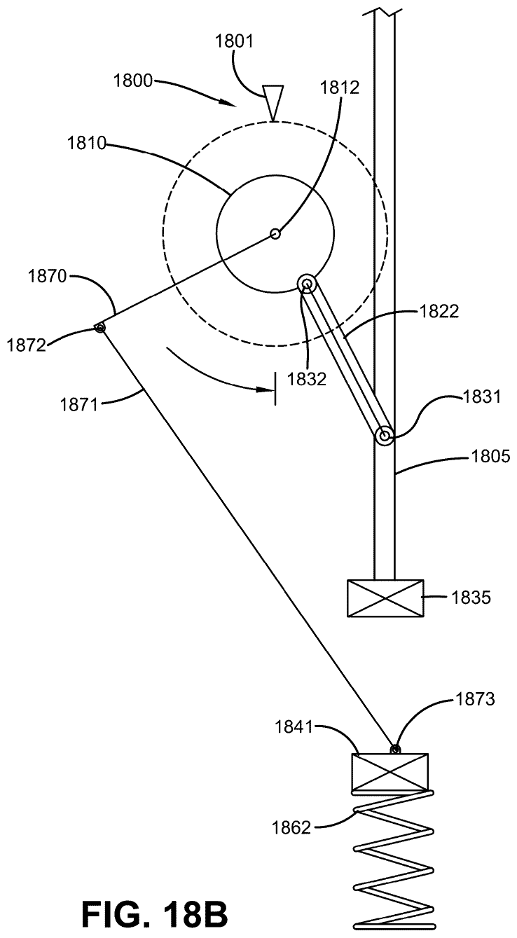

FIGS. 18A-B and 19A-B disclose variations of the system of FIG. 17 wherein the motion and energy transferred through the device is also be transferred to an associated pulley and/or linked lever lift assist that can moreover move the drive shaft forward to help get the kinetic mass back to its “ready” start position or to otherwise continue the rotation motion. Each of these variations utilize a lever arm that is coupled to the wheel through a one-way clutch mechanism or device that allows similar functionality of engaging for one direction travel only.

In FIG. 18A a modified system 1800 is disclosed that includes many of the same features shown in FIG. 17 and described above. The same features are numbered similarly using the 1800 series instead of the 200 series of numerals. Only one wheel 1810 is needed, the second spring 260, second rebound magnet 261, and piston magnets 235 are not shown in FIG. 18A-B and are optional, as are the lift assist mechanisms 290, 291. In FIGS. 18A and 18B, a channel and pin or another mechanism could be used to keep the piston arm 1805 in place allowing vertical travel with little or no horizontal motion. The triangle 1801 indicates the 12 o'clock position for reference.

The modified system 1800 utilizes a lever arm 1870 that extends from the wheel 1810 at an offset location that will not interfere with the travel of the coupling arm 1822. This location may be on the opposite side of the wheel 1810 from the side the coupling arm 1822 is on. The lever arm 1870 is rotatably coupled at a pivot point 1872 to a second arm 1871 in a bar linkage configuration. The second arm 1871 is rotatably coupled to a rebound magnet 1841 at a pivot point 1873.

FIG. 18A shows the modified system 1800 in a first position with the rebound magnet 1841 and spring 1862 in the fully extended up position. FIG. 18B shows the piston arm 1805 in a down position, which pushes the spring 1862 and the rebound magnet 1841 down also by the repelling magnetic force of piston magnet 1835 acting on the rebound magnet 1841. This causes a downward (and slightly inward) pull on the second arm 1871 of the bar linkage, resulting in a downward pull on the lever arm 1870, which, in turn, pulls the wheel 1810 in a counter-clockwise rotation aiding in the continued motion of the modified system 1800. The one-way clutch mechanism only allows the counterclockwise motion of the lever arm 1870 to affect the wheel 1810. The clutch disengages the lever arm 1870 from the wheel 1810 as the spring 1862 uncoils and the rebound magnet 1841 begins to move back up, and it pushes the second arm 1871 and the lever arm 1870 up. As the system 1800 moves back to the position shown in FIG. 18A, due to the one-way clutch mechanism, the upward clockwise motion of the lever arm 1870 does not interfere with the wheel's 1810 continuing counterclockwise motion.

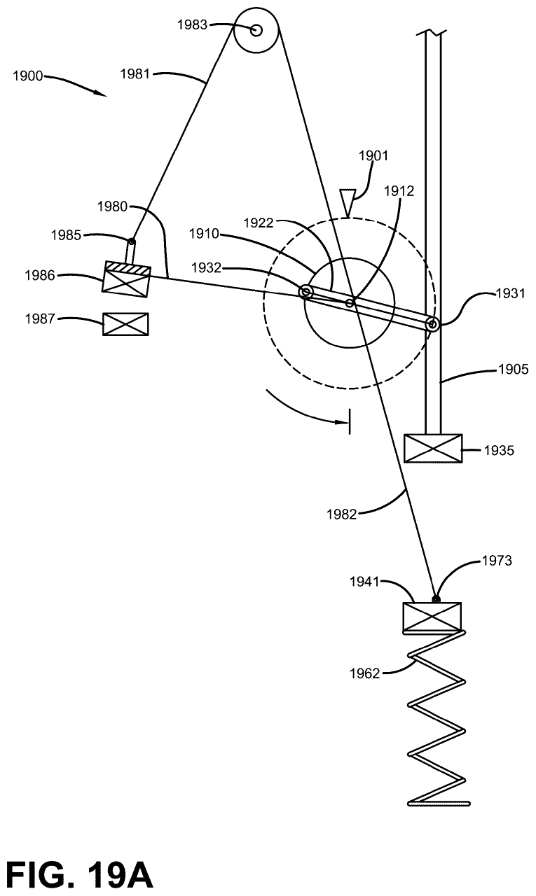

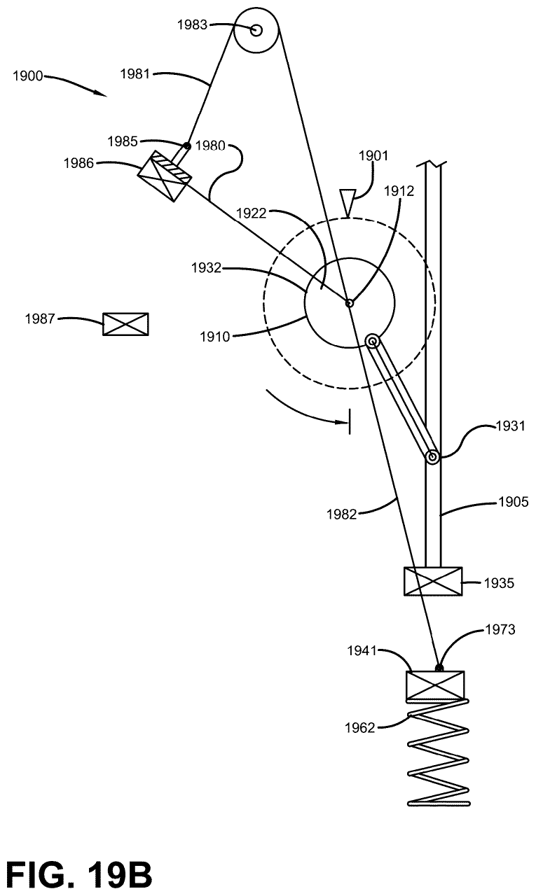

In FIG. 19A another modified system 1900 is disclosed that includes many of the same features shown in FIG. 17 and described above. The same features are numbered similarly using the 1900 series instead of the 200 series of numerals. Only one wheel 1810 is needed, the second spring 260, second rebound magnet 261, and piston magnets 235 are not shown in FIG. 18A-B and are optional, as are the lift assist mechanisms 290, 291. In FIGS. 19A and 19B, a channel and pin or another mechanism could be used to keep the piston arm 1905 in place allowing vertical travel with little or no horizontal motion. The triangle 1901 indicates the 12 o'clock position for reference.

The modified system 1900 utilizes a pulley system with a line including a first portion 1981 and a second portion 1982. The first portion 1981 is coupled to a first anchor point 1985 on a lever arm 1980 and/or lever magnet 1986 at an end of the lever arm 1980. The first portion 1981 extends up to a pulley 1983, then the second portion 1982 extends from the pulley 1983 to a second anchor point 1973 that is coupled to a rebound magnet 1941 on a spring 1962.

The lever arm 1980 extends from the wheel 1910 at a location that will not interfere with the travel of the coupling arm 1922. This location may be on the opposite side of the wheel 1910 from the side the coupling arm 1922 is on. The lever arm 1980 may be weighted to provide additional potential energy and tune the system 1900 for proper oscillation.

FIG. 19A shows the modified system 1900 in a first position with the rebound magnet 1941 and spring 1962 in the fully extended up position. FIG. 19B shows the piston arm 1905 in a down position, which pushes the spring 1962 and the rebound magnet 1941 down also by the repelling magnetic force of the piston magnet 1935 acting on the rebound magnet 1941. This causes a downward pull on the second portion 1982 of the line which is translated through the pulley 1983 to an upward pull on the first portion 1981 of the line. This results in an upward pull on the lever arm 1980, which, in turn, pulls the lever magnet 1986 up. The lever arm 1980 is coupled to the wheel 1910 by a one-way clutch mechanism, which does not allow the clockwise motion of the upward pull of the lever arm 1980 to affect the wheel 1910. However, when the lever arm 1980 is in the upward position (see FIG. 19B) and begins to drop as the piston arm 1905 rises, the spring 1962 uncoils, the rebound magnet 1941 goes up, and the upward pull on the pulley 1983 is released, the lever arm 1980 drops, and the lever magnet 1986 drops, this counterclockwise motion is translated to the wheel 1910. The clutch engages the lever arm 1980 to the wheel 1910 and the motion of the lever arm 1980 dropping imparts additional energy to the counterclockwise rotation of the wheel 1910. A supplemental magnet 1987 provides a low friction stop to the downward motion of the lever arm 1980 and lever magnet 1986, or if oscillations are tuned appropriately, the supplemental magnet can provide a push up to lever magnet 1986 as it starts being pulled back up via the pulley linkage.

Various mechanical, pneumatic, or electronic mechanisms could be used to tune the timing of the lever drop to aid in properly timing the oscillations of the modified systems 1800, 1900.

For the systems of FIGS. 16-19, the piston rod could be in a combustion (or other) control cylinder, as well as the other components. The maximum amount of magnetic deflection for stronger magnets would be 3−4+/−inches. These teachings can be applied to one or more pistons of a motor vehicle engine, such as inline-4, V-6, V-8, V-10, V-12 internal combustion engines, or flat horizontal engines such as for train driving linkage. Non-ferrous combustion and pneumatic engines like aluminum ones have a long track record of success, and could couple with the aforementioned magnetic apparatuses. In an embodiment, the systems disclosed herein can be used with one-piston connecting and coupling rods to one gear, e.g., as in train linkages. Locomotive driving wheels are all coupled together with side rods (also known as coupling rods); normally one pair is directly driven by the main rod (or connecting rod) which is connected to the end of the piston rod; power is transmitted to the others through the side rods.

The embodiments of FIGS. 17 to 19 may find particular value in engines producing high torque. The total travel of the wheel or wheels connected to the piston during its downward travel from top dead center TDC to bottom dead center BDC is along a circumference of about 134 degrees for counter-clockwise rotations FIGS. 18 to 19, and concomitantly about 226 degrees of travel back to TDC. This may well be more advantageous for combustion and applications needing high torque. In FIG. 17 the depicted left side clockwise rotation of first wheel 210 (as well as synced counter-clockwise right side second wheel 211) travels from TDC 226 degrees to BDC, resulting in 134 degrees travel back to TDC, which is more mechanically advantageous but may provide less torque.

Various other machines can be used in conjunction with the systems disclosed herein such as a rocker-slider function generator, rack-and-pinion four bar linkage, multiple-bar linkage mechanism, gear five-bar linkage, slider-crank mechanism, wheel and crank mechanism, RTRTR mechanism, a Crawford conicograph, an outward/inward folding deployable mechanism, and Grashof type four-bar kinematic inversion mechanism.

In embodiments, a lift assist system can be used in vertical alignments to assist all such machines in overcoming gravity on the upward motion of their traveling parts. Non-vertical or horizontal plane motion could also be aided by the lift assist systems disclosed herein. The teachings from, e.g., FIGS. 1-19 can be incorporated into mechanical devices that utilize rotary motion. The teachings from, e.g., FIGS. 17-19, can be incorporated with any mechanical device using vertical motion by utilizing the piston and rebound magnetic systems.

### EXAMPLES

Working examples of the devices shown in FIG. 1 and FIG. 7A have been constructed and tested. They have been shown to have increased efficiency over an unassisted wheel and other prior solutions. The system of FIG. 1 had an improvement in efficiency of over 10% for the same input on a standard wheel of the same dimensions and weight without the lift assist assembly. In embodiments it is believed that the system of FIG. 1 could achieve improvements in efficiency as calculated in these examples of 10.5% to 25%, or 11% to 20%, or 12% to 14%.

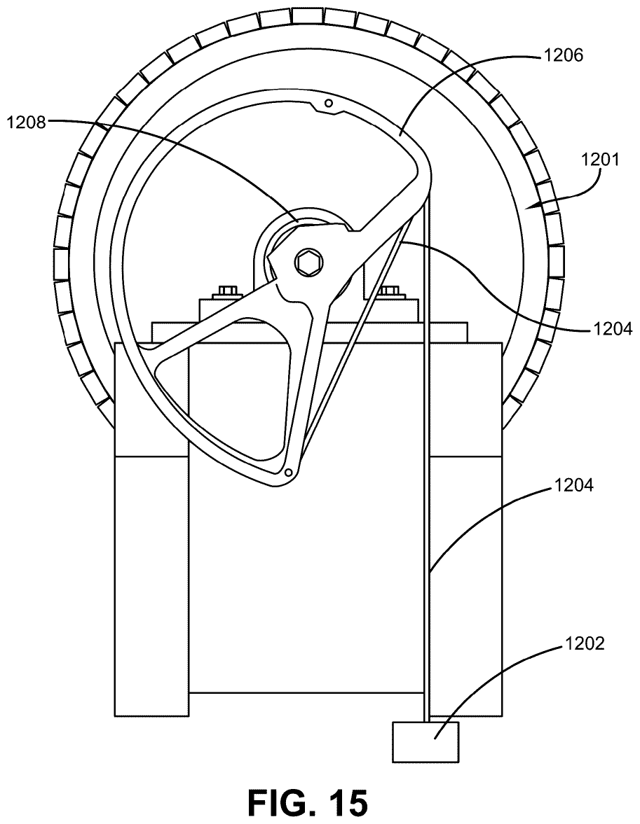

The experiment was conducted by dropping a two-pound weight 1202 on a string 1204 to start the motion of the wheel 1201 twelve times. The string 1204 was connected to and looped around an offset crossbow cam 1206, the cam 1206 being attached to the end of the shaft beyond the pillow bock bearing housing 1208 supporting the magnet wheel 1201. See FIG. 15. The weight 1202 was dropped 18 inches from the same spot at a repeatable static start position to begin the rotary motion. The string 1204 unwound and fell off the cam 1206 starting the motion and removing the weight 1202 from the system without tangling. The rotations of the wheel 1201 were then monitored. This was done on the same wheel 1201 without the lift assist assembly (Example 1-Comparative) and with the lift assist assembly (Example 2).

Twelve runs were conducted in the same manner, with Example 1 averaging a run time of 2:28 and Example 2 averaging a run time of 2:52 (a 24 second improvement) with high and low runs not part of the average. More details are shown with rotations per minute (RPMs) in Table 1.

TABLE 1

| | |
|---|---|
| Example 1 (Comparative) | Example 2 |

| Run Time | RPM | Run-time | RPM |
|---|---|---|---|
| 0 (just after start) | about 66 | 0 (just after start) | about 66 |
| 1:00 | 44 | 1:00 | 48 |
| 2:00 | 22 | 2:00 | 28 |
| 2:28 | 0 | 2:52 | 0 |

In Examples 3 and 4, twelve runs were conducted with the system of FIG. 1 at high speed by starting the rotation with a motor calibrated to 400 rpms. Table 2 reports the average of ten runs (excluding the high and low results). Example 3 is a comparative example run on the same wheel as Example 4 but without any lift assist assembly.

TABLE 2

| | |
|---|---|
| Example 3 (Comparative) | Example 4 |

| RPM | Time (minutes) | RPM | Time (minutes) |
|---|---|---|---|
| 400 begin, | 0 | 400 begin, | 0 |
| 345 | 1 | 349 | 1 |
| 300 | 2 | 307 | 2 |
| 260 | 3 | 269 | 3 |
| 225 | 4 | 237 | 4 |
| 195 | 5 | 206 | 5 |
| 165 | 6 | 178 | 6 |
| 135 | 7 | 153 | 7 |
| 110 | 8 | 130 | 8 |
| 90 | 9 | 108 | 9 |
| 66 | 10 | 88 | 10 |
| 44 | 11 | 68 | 11 |
| 22 | 12 | 48 | 12 |
| 0 (end) | 12:30 | 28 | 13 |
| | | 0 (end) | 14:00 |

### Example 5

The rotors of the device of FIG. 7A, were measured with an accurate hanging scale to have an actual weight of ten pounds at just before 6 o'clock, prior to the rotor entering into effective area of any magnets. Once loaded onto the lift assist assembly 160, the rotors had a magnetic float/flux modified weight of one pound. This provided a 10 to 1 differential mechanical advantage, providing a surprisingly effective mechanical advantage.

### Example 6-9

In a system constructed according to FIG. 16A, a commercial hanging scale was tethered to a pulley with a line running parallel to the approximate 33-degree inclined ramp. The weight registered a value approximating the “work” required to get the ramp vehicle up the ramp.

The test ramp included stator magnets 1610 as shown in FIG. 16 (Example 6); another section with a lift assist assembly 20 just under the ramp surface 1612 with geometry as shown in FIGS. 1 and 2 (Example 7); another section with a set of magnets placed end-to-end in a straight line (Example 8); and another section without any magnets (comparative Example 9). All these were tested with wheels 1620 and 1622 placed on the ramp 1605.

Multiple instances of consistent pull-force was applied to the bottom of the hanging scale to replicate work required to propel the apparatus upward. Examples 6 and 7 were found to be significantly superior to Examples 8 and 9. After much trial and error, front magnets 1685 and 1665 were determined to be at an ideal angle to deflect up and over each magnetic round/flux/“step” to the next one in a substantially consistent flux, and no areas were void of flux). The front magnet and second front magnet 1696, 1697 and 1676, 1677 help create the same magnetic round/flux/float that works so well in the device of FIGS. 7-14 and FIGS. 16-19B.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Furthermore, to the extent that the term “includes” is used in either the detailed description or the claims, such term is intended to be inclusive in a manner similar to the term “comprising” as “comprising” is interpreted when employed as a transitional word in a claim. The term “consisting essentially” as used herein means the specified materials or steps and those that do not materially affect the basic and novel characteristics of the material or method. If not specified above, any properties or measurements mentioned herein may be determined by applicable ASTM standards, or if an ASTM standard does not exist for the property, the most commonly used standard known by those of skill in the art may be used.

1. A motion transfer system comprising:
a wheel, configured to rotate vertically around a center axis of rotation, the wheel including a rim with a permanent magnetic array arranged on the rim that forms a magnetic array around the wheel;
a lift assist assembly including a permanent magnetic assembly configured to exert a magnetic repelling force against the permanent magnetic array in at least a portion of an area including 6 o'clock to 9 o'clock.

2. The motion transfer system of claim 1, wherein a top surface of the permanent magnetic assembly slopes downward as it extends toward a vertical mid-line of the wheel.

3. The motion transfer system of claim 1, wherein a top surface of the permanent magnetic assembly in an inner area of the lift assist assembly has a curvature following a shape of Equation I, in a range of x=1 to 5:
$$y = 0.936 + 0.1291429 x - 0.06285714 {x}^{2} \qquad ( Equation I )$$
wherein the top surface of the permanent magnetic assembly at a beginning of the inner area is defined as y=1, and for any x-coordinate in Equation I, the y coordinate can vary by −15% to 15%.

4. The motion transfer system of claim 1, wherein only magnetic influence on the rotational motion of the system is exerted in the area of 6 o'clock to 9 o'clock.

5. The motion transfer system of claim 1, wherein in a graph of magnetic force in an upward vector of the permanent magnetic assembly there are at least two inflection points.

6. The motion transfer system of claim 1, wherein the lift assist assembly has at least three vertical layers or steps, wherein a middle and top layer partially horizontally overlap a lower layer and strengthen a portion magnetic field of a bottom layer.

7. The motion transfer system of claim 1, wherein the permanent magnet assembly is configured to exert its strongest magnetic force in a vertical column centered outside of a radius of rotation of the wheel following a horizontal line from 9 o'clock, the vertical column being at a horizontal distance from an outer radius of the wheel at 9 o'clock of ⅙ to 1 times a length of the radius of the wheel or 1 to 6 inches.

8. The motion transfer system of claim 1, wherein the lift assist assembly is exclusively outside of a radius of rotation of the wheel.

9. A motion transfer system comprising:
a first arm having a first magnetic rotor and a second magnetic rotor on each end of the first arm, and a second arm having a first magnetic rotor and a second magnetic rotor on each end of the second arm;
the first arm and second arm coupled with a sliding mechanism to a hub configured to rotate vertically about a central axis; wherein the first and second arm are configured to slide radially to a maximum outer radius and a minimum inner radius as they rotate about the central axis;
a lift assist assembly including a permanent magnet assembly, configured to exert a magnetic repelling force against the first and second magnetic rotors on the first and second arms; in at least a portion of an area including 6 o'clock to 8 o'clock.

10. The motion transfer system of claim 9, wherein the permanent magnet assembly is configured to push diagonally up the first magnetic rotor of the first arm when the first magnetic rotor is from 6 o'clock to 8 o'clock.

11. The motion transfer system of claim 10, wherein the first magnetic rotor is at the minimum inner radius from 7 o'clock to 12 o'clock.

12. The motion transfer system of claim 10, wherein the second magnetic rotor is at the maximum outer radius when the first magnetic rotor is at the minimum inner radius.

13. The motion transfer system of claim 9, wherein the permanent magnet assembly intrudes into a pathway of a maximum radius of rotation of the first arm and second arm.

14. The motion transfer system of claim 11, wherein the system is configured to slide the first magnetic rotor to the maximum outer radius between 1:30 o'clock and 2:00 o'clock.

15. The motion transfer system of claim 9, wherein the first magnetic rotor comprises a rotor head with a front magnet, and a rear magnet coupled to the rotor head, each coupled to the rotor head and facing away from the central axis.

16. The motion transfer system of claim 9 wherein the permanent magnet assembly includes a top area configured to exert a stronger magnetic force than other areas of the permanent magnet assembly, and a top surface of the top area is oriented in a direction facing 12:30 to 1:30 o'clock.

17. A method for transferring motion, comprising:
applying a starting force to begin rotation of a magnetic rotor rotating vertically on a horizontal axis;
applying a magnetic repelling force against the magnetic rotor in at least a portion of an area of the rotation including 6 o'clock to 9 o'clock.

18. The method of claim 17, further comprising extracting energy from the rotation of the magnetic rotor.

19. The method of claim 17, wherein the magnetic rotor is a permanent magnetic array on a wheel.

20. The method of claim 17, wherein the magnetic rotor is slidably coupled to a central hub and further comprising: sliding and rotating the magnetic rotor diagonally up when the magnetic force is applied.

21-30. (canceled)
